(19) United States
(12) Patent Application Publication
(10) Pub. No.: US 2023/0261171 A1
(43) Pub. Date: Aug. 17, 2023

(54) HIGH ENERGY AND POWER DENSITY ANODE FOR BATTERIES AND METHOD FOR THE PRODUCTION THEREOF

(71) Applicant: HFG, DARDILLY (FR)

(72) Inventor: Fabien GABEN, Dardilly (FR)

(73) Assignee: I-TEN, DARDILLY (FR)

(21) Appl. No.: 18/003,229

(22) PCT Filed: Jun. 23, 2021
(86) PCT No.: PCT/IB2021/055537

§ 371 Date: Dec. 23, 2022

(30) Foreign Application Priority Data
Jun. 23, 2020 (FR) 2006530

(51) Int. Cl. H01M 4/04; H01M 10/0525; H01M 10/0562; H01M 4/58

(52) U.S. Cl. CPC H01M 4/0457; H01M 10/0525; H01M 4/0407; H01M 4/0409; H01M 4/0428; H01M 10/0562; H01M 4/5825; H01M 4/0471; H01M 2004/021

(57) ABSTRACT

An anodic member, an electrochemical device having an anodic member, and a method for manufacturing an anodic member for a lithium-ion battery. The method uses nanoparticles of an electrically insulating material that conducts lithium ions, is stable in contact with metallic lithium, does not insert lithium at potentials of between 0 V and 4.3 V with respect to the potential of the lithium, and has a relatively low melting point.

### CROSS-REFERENCE TO RELATED APPLICATION

The present application is a National Stage Application of PCT International Application No. PCT/IB2021/055537 (filed on Jun. 23, 2021), under 35 U.S.C. § 371, which claims priority to French Patent Application No. FR 2006530 (filed on Jun. 23, 2020), which are each hereby incorporated by reference in their complete respective entireties.

### TECHNICAL FIELD

The invention relates to the field of electrochemistry, in particular electrochemical systems. It relates more specifically to anodes that can be used in electrochemical systems such as high-power batteries, in particular lithium-ion batteries. The invention relates to anodic members.

The invention also relates to a method for preparing such anodic members, which uses nanoparticles of an electrically insulating material that conducts lithium ions, is stable in contact with metallic lithium, does not insert lithium at potentials of between 0 V and 4.3 V with respect to the potential of the lithium, and has a relatively low melting point, and the anodes thus obtained. The invention also relates to a method for manufacturing an electrochemical device comprising at least one such anodic member and such an anode, and the lithium-ion batteries thus obtained.

### BACKGROUND

To meet the requirements of miniaturization and of endurance, ever more compact batteries storing high energy densities, less expensive and provided with power must be developed.

To produce more compact and less expensive batteries, using materials having a high capacity per unit mass (mAh/g), provided with high densities and/or producing electrodes that are as little porous as possible is known. However, reducing the porosity of the electrodes decreases their specific surface area, increases their resistance and reduces their power.

To increase the endurance of the batteries in a given volume, increasing the operating voltage of the cells is also known. The operating voltage results from the difference in potential between the anodes and cathodes. In order to increase this difference in potential, it is necessary to have electrodes having a very wide electrochemical-stability window. These electrolytes must not undergo chemical transformation in contact with the anodes operating at very low potentials, or in contact with cathodes operating at very high potentials.

At the present time, only a few solid electrolytes make it possible to meet this requirement of very high stability. Moreover, reducing the operating potential of the anodes also gives rise to a risk of forming lithium dendrites during the recharging of the battery. The growth of these lithium dendrites may give rise to a risk of short-circuit in the battery that may cause thermal runaway. Although solid and stable in contact with metallic lithium, some ceramic electrolytes are not free from these risks of short-circuit. Many ceramic solid electrolytes are obtained by sintering powders, and the interfaces between the grains remain fragile regions in which the lithium dendrites can form. In addition, these solid ceramic electrolytes are lithiophobic, causing a poor interface contact between the metallic lithium and the solid electrolyte; the lithium preferably precipitating in the grain joints.

To produce batteries with a very high energy density, it is necessary to develop anodes operating at a very low potential. However, anodes having high energy density also have a high variation in volume during charging and discharging cycles. This variation in volume may be of the order of 100% for anodes making metallic lithium, or even more than 250% for anodes based on silicon or germanium. It poses many problems. First of all, it is necessary for the anode formed from such materials to be very porous in order to be able to accept such a variation in volume, but this great porosity reduces the energy density per unit volume of the electrode. Moreover, to operate, these electrodes are impregnated with a liquid electrolyte that is non-compressible, and any variation in volume causes a movement of liquid electrolyte, and consequently a dimensional change in the encapsulation system. It then becomes very difficult to have an encapsulation that is perfectly impervious over time and capable of accommodating these variations in volume. In addition, this very high variation in volume during the charging and discharging cycles ends by damaging the electrodes; these cyclic dimensional variations cause a loss of electrical contact on the one hand within the anode material and on the other hand between the active anode materials and the electrolytes and enters the anode materials and the current collectors. They also contribute to the deterioration of the SEI (surface electrolyte interface) layers covering the anodes.

In order to produce anodes with a high energy density, the National Renewable Energy Laboratory has developed a so-called “buried” anode. It is manufactured in situ in a structure comprising a substrate such as a metal sheet, an electrolyte in the solid state and a cathode containing lithium such as lithium and manganese oxide by applying a voltage between the substrate and the cathode of this structure. This voltage causes the migration of the lithium ions towards the surface of the substrate, where they form a metallic-lithium anode at the interface between the solid electrolyte and the substrate (see https://www.nrel.gov/docs/fy11osti/49149.pdf). Because the anode is deposited in this interface, the thickness of this anode must be very small to avoid degrading the solid electrolyte film during the recharging of the battery. This constraint limits the capacity of the anode and causes many reliability problems. In this type of structure, the location of the electrodeposition regions is not well defined, just like the interface between the lithium anode and the solid electrolyte. The surface allowing the diffusion of the lithium is very small (planar structure defined at the interface between the electrolyte and the substrate) and considerably limits the power.

In order to facilitate the transport of the lithium ions, Yang proposed using a host matrix of solid electrolyte material of the garnet type for accommodating the deposits of metallic lithium during the charging of the battery. This architecture makes it possible to ensure progressive filling of the lithium anode between the current-collecting substrate and the dense electrolyte layer (“Continuous plating/stripping behavior of solid-state lithium metal anode in 3D ion-conductive framework”, PNAS, 10 Apr. 2018). This host matrix, with a porosity per unit volume of 50%, was produced by casting, in a strip, a paste containing micrometric particles of solid electrolyte of Li₇La_{2.75}Ca_{0.25}Zr_{1.75}Nb_{0.25}O₁₂ and particles of polymethylmethacrylate. The polymethylmethacrylate particles are integrated solely in place of the future host structure.

This is because, during sintering at more than 1000° C., these particles will go into gaseous phase and thus help to create porosity in the structure. The regions of the strip that do not have polymethylmethacrylate particles will sinter completely and form a dense film, without porosity, which will serve as a solid electrolyte. Because of the very high sintering temperatures, this technique cannot be implemented on metal substrates. The electrical connections are then produced by metallization of the surface of the sintered body. This technology consequently remains very expensive to implement, the thickness of the electrolyte is great, and the porosity is of micrometric order. Moreover, the solid electrolyte materials of the garnet type are not stable at more than 4 V and cannot be used with cathodes for making batteries provided with high energy density. They are on the other hand stable in contact with metallic lithium, which, in the context of the prior art previously described, made it possible to make a symmetrical cell in which the deposition (or plating) of lithium is implemented in alternation on each side of the solid electrolyte.

With this architecture, it is possible to obtain batteries with high energy density. This is because lithium has a theoretical capacity of 3600 mAh/g, i.e. 1900 mAh/cm³. The host structure having a porosity of 50%, the effective capacity density per unit volume of the anode is then 950 mAh/cm³. The capacity per unit volume of this type of architecture is in principle less than that of silicon anodes. However, even if silicon anodes have a maximum theoretical capacity per unit volume of 4000 mAh/cm³, the variation in volume being 400%, they must be used with more than 80% porosity to deliver such a capacity, which ultimately gives a theoretical effective capacity per unit volume of 1000 mAh/cm³; this value is very close to that of the host structures of lithium. These host structures are moreover more reliable and can be used in a completely solid architecture because of the absence of variations in volume during the charging and discharging steps. The host structures of the prior art have a low power density, which is related essentially to the relatively small specific surface area of the anode.

The present invention seeks to remedy the drawbacks of the prior art mentioned above.

More specifically, the problem that the present invention seeks to solve is providing a method for manufacturing anodes that is simple, safe, quick, easy to implement and inexpensive.

The present invention also aims to propose safe anodes having mechanically stable structure, good thermostability and long service life.

Another aim of the invention is to propose anodes for batteries with high energy and power density capable of operating at high temperature without any problem of reliability or internal short-circuit and without risk of fire.

Another aim of the invention is to provide a method that can easily be applied industrially on a large scale for manufacturing a non-charged battery comprising an anodic member according to the invention.

Another aim of the invention is to provide a method that can easily be applied industrially on a large scale and is simple, safe, quick, easy to implement and inexpensive for manufacturing a battery loaded with metallic lithium, comprising an anode according to the invention.

Yet another aim of the invention is to propose batteries, in particular lithium-ion batteries, capable of storing a high energy density, restoring this energy with very high power density and withstanding high temperatures, having a long service life and able to be encapsulated by claddings deposited directly on the battery, and that are thin, rigid and preferably impervious to the permeation of gases to atmosphere.

### SUMMARY

According to the invention, the problem is solved by a porous anodic member formed by a solid layer of material conducting lithium ions, including an open porosity lattice, that is integrated in a lithium-ion battery; during the first charging of the battery, metallic lithium is deposited in this open porosity lattice, to transform the anodic member into an anode.

A first object of the invention is a method for manufacturing an anodic member for a lithium-ion battery designed to have a capacity greater than 1 mA h, said battery comprising at least one cathode, at least one electrolyte and at least one anode, said anode comprising: said anodic member, comprising a porous layer disposed on a substrate, preferably on a metal surface of a substrate, said porous layer having a porosity of between 35% and 70% by volume, and metallic lithium loaded inside the pores of said porous layer, said method comprising the following steps:

(a) a substrate is provided, and a colloidal suspension comprising aggregates or agglomerates of monodisperse nanoparticles of at least one first electrically insulating material conducting lithium ions with a mean primary diameter D₅₀ of between 5 nm and 100 nm, said aggregates or agglomerates having a mean diameter of less than 500 nm;

(b) a porous layer is deposited on at least one face of said substrate from said colloidal suspension provided at step (a), by a method selected from the group formed by electrophoresis, by printing methods, in particular by inkjet or by flexographic printing, by coating methods and in particular by doctor blade, by roll, by curtain, through a die in the form of a slot and by dip coating, and by spraying techniques, on the understanding that said substrate may be a substrate capable of acting as a collector of electrical current of the battery or an intermediate substrate;

(c) said porous layer obtained at step (b) is dried, preferably under a flow of air, where applicable before or after having separated said porous layer from its intermediate substrate, and then, optionally, a heat treatment of the dried layer is implemented.

Advantageously, when the substrate is an intermediate substrate, also, during step (a), the following are provided:

at least one electrically conductive sheet can serve as a current collector of the battery,

a conductive glue or a colloidal suspension comprising monodisperse nanoparticles of at least one second material conducting lithium ions with a mean primary diameter D₅₀ of between 5 nm and 100 nm; and

after separation of said porous layer from its intermediate substrate, a heat treatment of the porous layer is implemented, and then, on at least one face, preferably on both faces, of said electrically conductive sheet, a thin layer of conductive glue or a thin layer of nanoparticles is deposited from the colloidal suspension comprising monodisperse nanoparticles of at least one second material conducting lithium ions, the second material conducting lithium ions preferably being identical to the first material conducting lithium ions; then the porous layer is adhesively bonded on said face, preferably on both faces of said electrically conductive sheet.

Advantageously, the thin layer of conductive glue or a thin layer of nanoparticles from the colloidal suspension comprising monodisperse nanoparticles of at least one second material conducting lithium ions has a thickness of less than 2 μm, preferably less than one micrometer, and more preferably less than 500 nm.

Advantageously, the substrate capable of acting as an electrical current collector has a metal surface.

Advantageously, when said substrate is an intermediate substrate, said layer is separated from said intermediate substrate, to form, after consolidation, a porous wafer. This separation step may be implemented before or after drying the layer obtained at the step b). Said optional heat treatment at step (c) aims in particular at eliminating any organic residues, and consolidating the layer and/or recrystallizing same. Said optional heat treatment at step (c) may consist of a plurality of heat treatment steps, in particular a succession of heat treatment steps. Said optional heat treatment at step (c) may comprise a first step for debonding, i.e. eliminating organic residues, and a second for consolidating the porous layer.

Advantageously, after step (c), during a step (d), a layer of a lithiophilic material is deposited on and inside the pores of the porous layer, preferably by the atomic layer deposition (ALD) technique or by chemical solution deposition (CSD).

Advantageously, the lithiophilic material is selected from ZnO, Al, Si, CuO.

Advantageously, the metal substrate is selected from copper, nickel, molybdenum, tungsten, niobium or chromium strips, or alloy strips comprising at least aforementioned elements.

Advantageously, the primary diameter of said monodisperse nanoparticles is between 10 nm and 50 nm, preferably between 10 nm and 30 nm.

In one embodiment, the mean diameter of the pores of the porous layer is between 2 nm and 500 nm, preferably between 2 nm and 250 nm, more preferentially between 2 nm and 80 nm, even more preferentially between 6 nm and 50 nm, and even more preferentially between 8 nm and 30 nm.

Advantageously, the mean diameter of the pores of the porous layer is between 2 nm and 50 nm, preferably between 2 nm and 30 nm.

Advantageously, the porous layer has a porosity of approximately 50% by volume.

Advantageously, said material conducting lithium ions is selected from the group formed by:
lithiated phosphates, preferably selected from: lithiated phosphates of the following types: NaSICON, Li₃PO₄; LiPO₃; Li₃Al_{0.4}Sc_{1.6}(PO₄)₃ called “LASP”; Li₁₊ₓZr₂₋ₓCaₓ(PO₄)₃ with 0≤x≤0.25; Li₁₊₂ₓZr₂₋ₓCaₓ(PO₄)₃ with 0≤x≤0.25 such as Li_{1.2}Zr_{1.9}Ca_{0.1}(PO₄)₃ or Li_{1.4}Zr_{1.8}Ca_{0.2}(PO₄)₃; LiZr₂(PO₄)₃; Li₁₊₃ₓZr₂(P₁₋ₓSiₓO₄)₃ with 1.8<x<2.3; Li₁₊₆ₓZr₂(P₁₋ₓBₓO₄)₃ with 0≤x≤0.25; Li₃(Sc₂₋ₓMₓ)(PO₄)₃ with M=Al and/or Y and 0≤x≤1; Li₁₊ₓMₓ(Sc)₂₋ₓ(PO₄)₃ with M=Al, Y, Ga or a mixture of these three elements and 0≤x≤0.8; Li₁₊ₓMₓ(Ga_{1-y}Sc_{y})₂₋ₓ(PO₄)₃ with 0≤x≤0.8; 0≤y≤1 and M=Al and/or Y; Li₁₊ₓMₓ(Ga)₂₋ₓ(PO₄)₃ with M=Al and/or Y 0≤x≤0.8; Li_{3+y}(Sc₂₋ₓMₓ)Q_{y}P_{3-y}O₁₂ with M=Al and/or Y and Q=Si and/or Se, 0≤x≤0.8 and 0≤y≤1; or Li_{1-x-y}MₓSc₂₋ₓQ_{y}P_{3-y}O₁₂ with M=Al, Y, Ga or a mixture of these three elements and Q=Si and/or Se, 0≤x≤0.8 and 0≤y≤1; or Li_{1+x+y+z}Mₓ(Ga_{1-y}Sc_{y})₂₋ₓQ_{z}P_{3-z}O₁₂ with 0≤x≤0.8, 0≤y≤1, 0≤z≤0.6 with M=Al and/or Y and Q=Si and/or Se; or Li₁₊ₓZr₂₋ₓBₓ(PO₄)₃ with 0≤x≤0.25; or Li₁₊ₓZr₂₋ₓCaₓ(PO₄)₃ with 0≤x≤0.25; or Li₁₊ₓM³ₓM₂₋ₓP₃O₁₂ with 0≤x≤1 and M³=Cr, V, Ca, B, Mg, Bi and/or Mo, M=Sc, Sn, Zr, Hf, Se or Si, or a mixture of these elements;
lithiated borates, preferably selected from: Li₃(Sc₂₋ₓMₓ)(BO₃)₃ with M=Al or Y and 0≤x≤1; Li₁₊ₓMₓ(Sc)₂₋ₓ(BO₃)₃ with M=Al, Y, Ga or a mixture of these three elements and 0≤x≤0.8; Li₁₊ₓMₓ(Ga_{1-y}Sc_{y})₂₋ₓ(BO₃)₃ with 0≤x≤0.8, 0≤y≤1 and M=Al or Y; Li₁₊ₓMₓ(Ga)₂₋ₓ(BO₃)₃ with M=Al and/or Y and 0≤x≤0.8; Li₃BO₃, Li₃BO₃—Li₂SO₄, Li₃BO₃—Li₂SiO₄, Li₃BO₃—Li₂SiO₄—Li₂SO₄; Li₃Al_{0.4}Sc_{1.6}(BO₃)₃; Li₁₊ₓZr₂₋ₓCaₓ(BO₃)₃ with 0≤x≤0.25; Li₁₊₂ₓZr₂₋ₓCaₓ(BO₃)₃ with 0≤x≤0.25 such as Li_{1.2}Zr_{1.9}Ca_{0.1}(BO₃)₃ or Li_{1.4}Zr_{1.8}Ca_{0.2}(BO₃)₃; LiZr₂(BO₃)₃; Li₁₊₃ₓZr₂(B₁₋ₓSiₓO₃)₃ with 1.8≤x≤2.3; Li₁₊₆ₓZr₂(P₁₋ₓBₓO₄)₃ with 0<x≤0.25; Li₃(Sc₂₋ₓMₓ)(BO₃)₃ with M=Al and/or Y and 0≤x≤1; Li₁₊ₓMₓ(Sc)₂₋ₓ(BO₃)₃ with M=Al, Y, Ga or a mixture of these three elements and 0≤x≤0.8; Li₁₊ₓMₓ(Ga_{1-y}Sc_{y})₂₋ₓ(BO₃)₃ with 0≤x≤0.8; 0≤y≤1 and M=Al and/or Y; Li₁₊ₓMₓ(Ga)₂₋ₓ(BO₃)₃ with M=Al and/or Y 0≤x≤0.8; Li_{3+y}(Sc₂₋ₓMₓ)Q_{y}B_{3-y}O₉ with M=Al and/or Y and Q=Si and/or Se, 0≤x≤0.8 and 0≤y≤1; or Li_{1-x-y}MₓSc₂₋ₓQ_{y}B_{3-y}O₉ with M=Al, Y, Ga or a mixture of these three elements and Q=Si and/or Se, 0≤x≤0.8 and 0≤y≤1; or Li_{1+x+y+z}M(Ga_{1-y}Sc_{y})₂₋ₓQ_{z}B_{3-z}O₉ with 0≤x≤0.8, 0≤y≤1, 0≤z≤0.6 with M=Al and/or Y and Q=Si and/or Se; or Li₁₊ₓZr₂₋ₓBₓ(BO₃)₃ with 0≤x≤0.25; or Li_{1+X}Zr_{2-X}Caₓ(BO₃)₃ with 0≤x≤0.25; or Li₁₊ₓM³ₓM₂₋ₓ(BO₃)₃ with 0≤x≤1 and M³=Cr, V, Ca, B, Mg, Bi and/or Mo, M=Sc, Sn, Zr, Hf, Se or Si, or a mixture of these elements;

oxynitrides, preferably selected from Li₃PO₄₋ₓN_{2x/3} and Li₃BO₃₋ₓN_{2x/3} with 0<x<3;

lithiated compounds based on lithium phosphorus oxynitride, called “LiPON”, in the form of LiₓPO_{y}N_{z} with x˜2.8 and 2y+3z˜7.8 and 0.16≤z≤0.4, and in particular Li_{2.9}PO_{3.3}N_{0.46}, but also the compounds Li_{w}POₓN_{y}S_{Z} with 2x+3y+2z=5=w or the compounds Li_{w}POₓN_{y}S_{z} with 3.2≤x≤3.8, 0.13≤y≤0.4, 0≤z≤0.2, 2.9≤w≤3.3, or the compounds in the form of LiₜPₓAl_{y}OᵤNᵥS_{w} with 5x+3y=5, 2u+3v+2w=5+t, 2.9≤t≤3.3, 0.84≤x≤0.94, 0.094≤y≤0.26, 3.2≤u≤3.8, 0.13≤v≤0.46, 0≤w≤0.2;

materials based on lithium phosphorus or lithium boron oxynitrides, called respectively “LiPON” and “LIBON”, also able to contain silicon, sulfur, zirconium, aluminum, or a combination of aluminum, boron, sulfur and/or silicon, and boron for materials based on lithium phosphorus oxynitrides;

lithiated compounds based on lithium silicon phosphorus oxynitride called “LiSiPON”, and in particular Li_{1.9}Si_{0.28}P_{1.0}O_{1.1}N_{1.0};

lithium oxynitrides of the LiBON, LiBSO, LiSiPON, LiSON, thio-LiSiCON and LiPONB types (where B, P and S represent respectively boron, phosphorus and sulfur);

lithium oxides of the LiBSO type such as (1−x)LiBO₂-xLi₂SO₄ with 0.4 x 0.8;

silicates, preferably selected from Li₂Si₂O₅, Li₂SiO₃, Li₂Si₂O₆, LiAlSiO₄, Li₄SiO₄, LiAlSi₂O₆;

solid electrolytes of the anti-perovskite type selected from: Li₃OA with A a halide or a mixture of halides, preferably at least one of the elements selected from F, Cl, Br, I or a mixture of two or three or four of these elements; Li₍₃₋ₓ₎M_{x/2}OA with 0<x 3, M a divalent metal, preferably at least one of the elements selected from Mg, Ca, Ba, Sr or a mixture of two or three or four of these elements, A a halide or a mixture of halides, preferably at least one of the elements selected from F, Cl, Br, I or a mixture of two or three or four of these elements; Li₍₃₋ₓ₎M³_{x/3}OA with 0 x 3, M³ a trivalent metal, A a halide or a mixture of halides, preferably at least one of the elements selected from F, Cl, Br, I or a mixture of two or three or four of these elements; or LiCOX_{Z}Y_{(1-z)}, with X and Y halides as mentioned above in relation to A, and 0 z 1.

It is preferred to use phosphates containing solely metallic dopants based on Zr, Sc, Y, Al, Ca, B and/or optionally Ga, borates containing solely metallic dopants based on Zr, Sc, Y, Al, Ca, B and/or optionally Ga, or materials comprising mixtures of phosphates and borates such as those cited above, since these materials are stable both at the operating potential of anodes comprising metallic lithium and cathodes. The use of this type of material makes it possible to make host structures that are stable over time, and which do not degrade. Moreover, phosphates have low melting points and partial coalescence of these materials by sintering (hereinafter referred to as the phenomenon of “necking”) can be done at relatively low temperature, especially when the particles are nanometric, which represents an additional economic advantage.

More particularly, it is preferred to use phosphates of the following types: Li₁₊ₓZr₂₋ₓCaₓ(PO₄)₃ with 0≤x≤0.25; Li₁₊₂ₓZr₂₋ₓCaₓ(PO₄)₃ with 0≤x≤0.25 such as Li_{1.2}Zr_{1.9}Ca_{0.1}(PO₄)₃ or Li_{1.4}Zr_{1.8}Ca_{0.2}(PO₄)₃; LiZr₂(PO₄)₃; Li₁₊₃ₓZr₂(P₁₋ₓSiₓO₄)₃ with 1.8<x<2.3; Li₁₊₆ₓZr₂(P₁₋ₓBₓO₄)₃ with 0≤x≤0.25; or Li₁₊ₓZr₂₋ₓBₓ(PO₄)₃ with 0≤x≤0.25; or Li₁₊ₓZr₂₋ₓCaₓ(PO₄)₃ with 0≤x≤0.25; or Li₁₊ₓM³ₓM₂₋ₓP₃O₁₂ with 0≤x≤1 and M³=Ca, B, Mg, Bi and/or Mo, M=Sc, Sn, Zr, Hf, Se or Si, or a mixture of these elements, since these phosphates are even more stable both at the operating potential of the anodes comprising metallic lithium and cathodes. The use of the latter materials makes it possible to make host structures that are particularly stable over time, and which do not degrade. Moreover, these phosphates have low melting points and partial coalescence of these materials by sintering can be done at relatively low temperature, especially when the particles are nanometric, which has an economic advantage.

Another object of the invention relates to a method for manufacturing an anode located inside a lithium-ion battery battery designed to have a capacity greater than 1 mA h, said battery comprising at least one cathode, at least one electrolyte and at least one anode, said anode comprising an anodic member capable of being manufactured by the method according to the invention, said method for manufacturing the anode being characterized in that the pores of said porous layer are loaded with metallic lithium during the first charging of the battery. The loading of the pores of said porous layer with metallic lithium preferably takes place during the charging of the battery.

Another object of the invention relates to an anodic member for a lithium-ion battery with a capacity greater than 1 mAh, capable of being obtained by the method according to the invention.

Advantageously, the anodic member according to the invention does not contain any organic compounds.

Another object of the invention relates to a method for manufacturing a non-charged lithium-ion battery designed to have a capacity greater than 1 mA h, implementing the method for manufacturing an anodic member according to the invention and comprising the steps of:

(1) preparing an anodic member disposed on a substrate, preferably on a metal substrate, or adhesively bonded to an electrically conductive sheet, said substrate or said electrically conductive sheet being able to serve as a current collector of the battery;

(2) preparing a cathode on a substrate, which may be a metal substrate that can serve as a current collector of the battery;

(3) depositing a colloidal suspension of solid electrolyte particles on the anode and/or on the cathode, followed by drying; and

(4) face-to-face stacking of the anodic member and of the cathode, followed by thermopressing.

The steps (1) and (2) can optionally be reversed and/or implemented in parallel. At step (2), the cathode can be obtained in various ways. It may be a case of a completely solid cathode, deposited for example under vacuum; the thickness of these cathodes is in practice limited by the resistivity thereof. Said cathode may also be a cathode including polymers loaded with lithium salt or mixed with liquid electrolytes containing a lithium salt, as well as active-material powders (cathode materials) and conductive fillers. Said cathode may also be a completely solid mesoporous cathode, based on nanoparticles of active materials that have undergone thermal consolidation to create an open mesoporosity lattice within a solid lattice, conducting lithium ions, formed by the coalescence of solid particles during thermal consolidation thereof; this solid lattice may be covered with a nanometric layer of an electron-conducting material that covers the whole of the open porosity.

The need to deposit this fine layer of electron conductor depends on the thickness of the electrode: if the electrode is very thin, this layer is not necessary. In an advantageous embodiment a thick, mesoporous, partially sintered cathode is used, covered with a nanolayer of an electron conductor.

Said mesoporous cathode that is used in a preferred embodiment of the battery according to the invention can next be impregnated with an electrolyte, which can be selected from the group formed by: electrolytes composed of at least one aprotic solvent and of at least one lithium salt; electrolytes composed of at least one ionic liquid or ionic polyliquid and of at least one lithium salt; mixtures of at least one aprotic solvent and of at least one ionic liquid or ionic polyliquid and of at least one lithium salt; polymers made ionic conductors by adding at least one lithium salt; and polymers made ionic conductors by adding a liquid electrolyte, either in the polymer phase or in the mesoporous structure; on the understanding that said polymers are preferably selected from the group formed by polyethylene oxide, abbreviated to PEO, polypropylene oxide, abbreviated to PPO, polydimethylsiloxane, abbreviated to PDMS, polyacrylonitrile PAN, polymethylmethacrylate, abbreviated to PMMA, polyvinylchloride, abbreviated to PVC, polyvinylidene fluoride, abbreviated to PVDF, polyvinylidene fluoride-co-hexafluoropropylene, or polyacrylic acid, abbreviated to PAA.

At step (2) said cathode may also be a cathode+solid electrolyte subassembly previously impregnated with a liquid electrolyte, such as an ionic liquid.

In one embodiment of this method, the following procedure is followed:

(i) providing:
a cathode layer disposed on a substrate, preferably on a metal substrate, said substrate being able to serve as a current collector of the battery;
a colloidal suspension comprising aggregates or agglomerates of monodisperse nanoparticles of at least one first electrically insulating material conducting lithium ions with a mean primary diameter D₅₀ of between 5 nm and 100 nm, said aggregates or agglomerates having a mean diameter of less than 500 nm;
at least one substrate, said substrate being able to be a metal substrate able to serve as a current collector of said battery or be an intermediate substrate;
when an intermediate substrate is provided, providing: at least one electrically conductive sheet able to serve as a current collector of the battery; and a conductive glue or a colloidal suspension comprising monodisperse nanoparticles of at least one second material conducting lithium ions with a mean primary diameter D₅₀ of between 5 nm and 100 nm;

(ii) depositing at least one porous layer, by electrophoresis, by the inkjet printing method, by doctor blade, by spraying, by flexographic printing, by roller coating, by curtain coating or by dip coating, using said colloidal suspension comprising aggregates or agglomerates of monodisperse nanoparticles of the at least one first material conducting lithium ions on said substrate and/or on said cathode layer;

(iii) drying the layer thus obtained at step (ii), where applicable before or after having separated the layer from its intermediate substrate, optionally followed by heat treatment, preferably under oxidizing atmosphere, of the dried layer obtained,

(a) and, when the intermediate substrate is used, depositing on at least one face, preferably on both faces, of said electrically conductive sheet, a thin layer of conductive glue or a thin layer of nanoparticles using the colloidal suspension comprising monodisperse nanoparticles of at least a second material conducting lithium ions, the second material conducting the lithium ions preferably being identical to the first material conducting lithium ions;

(b) followed by the adhesive bonding of the porous layer on said face, preferably on both faces of said electrically conductive sheet;

(iv) optionally, depositing, by the atomic layer deposition ALD technique, a layer of a lithiophilic material on and inside the pores of the porous layer obtained at step (iii);

(v) optionally, depositing a layer of solid electrolyte on the cathode layer and/or on the porous layer obtained at step (iii) and/or step (iv), said layer of solid electrolyte being obtained from an electrolyte material having an electron conductivity of less than 10⁻¹⁰ S/cm, preferably less than 10⁻¹¹ S/cm, electrochemically stable in contact with metallic lithium and at the operating potential of the cathodes, having an ion conductivity greater than 10⁻⁶ S/cm, preferentially greater than 10⁻⁵ S/cm, and having good quality of ionic contact between the solid electrolyte and the porous layer;

(vi) drying the layer thus obtained at step (v);

(vii) producing a stack comprising an alternating succession of cathode and porous layers, preferably offset laterally;

(viii) hot pressing the stack obtained at step (vii) so as to juxtapose the films obtained at step (v) present on the anode and cathode layers, and so as to obtain an assembled stack.

The same remarks as those made on step (2) above apply to step (i).

At step (iii), said optional heat treatment makes it possible in particular to eliminate any organic residues, to consolidate the layer and/or to recrystallize same.

At step (v) the deposition of a layer of solid electrolyte can be implemented by any other suitable means, for example using a suspension of core-shell nanoparticles comprising particles of a material able to serve as a solid electrolyte, on which a polymer shell is grafted. This polymer is preferably PEO, but may more generally be selected from the group formed by: PEO, PPO, PDMS, PAN, PMMA, PVC, PVDF, polyvinylidene fluoride-co-hexafluoropropylene or polyacrylic acid.

In a particular embodiment, after step (viii), and also after step (4) described above:
an encapsulation system is deposited successively, in alternation, on the assembled stack,
the anode and cathode connections of the assembled stack thus encapsulated are bared, by any means,
terminations (electrical contacts) are added where the cathode and respectively anode connections are visible.

These electrical contact regions are preferably disposed on opposite sides of the stack of the battery for collecting the current. The connections are metalized by means of techniques known to a person skilled in the art, preferably by immersion in a conductive resin and/or a molten tin bath, preferably in a conductive epoxy resin and/or a molten tin bath.

The terminations may be made in the form of a single metal layer, tin for example, or consist of multilayers. Preferably, the terminations consist, in the region of the cathode and anode connections, of a first stack of layers comprising successively a first layer of conductive polymer, such as a resin filled with electrically conductive particles, in particular a resin filled with silver, a second layer of nickel deposited on the first layer and a third layer of tin deposited on the second layer. The layers of nickel and tin can be deposited by electrodeposition techniques.

In this three-layer complex, the electrically conductive particles of the resin filled with electrically conductive particles may be of micron and/or nanometric size. They may consist of metals, alloys, carbon, graphite, conductive carbides and/or nitrides, or a mixture of these compounds.

In this three-layer complex, the nickel layer protects the polymer layer during the steps of assembly by welding, and the tin layer provides the weldability of the interface of the battery.

The terminations make it possible to take up the positive and negative electrical connections on the top and bottom faces of the battery. These terminations make it possible to produce the electrical connections in parallel between the various battery elements. The cathode connections preferably emerge on a lateral side of the battery, and the anode connections are preferably available on the other lateral side.

Another object of the invention relates to a method for manufacturing a charged battery having a capacity greater than 1 mA h, implementing the method for manufacturing a non-charged battery according to the invention, comprising an additional step of loading the pores of the porous layer with metallic lithium during the first charging of the non-charged battery.

Another object of the invention relates to an anode able to be obtained by the method according to the invention, said anode comprising a porous layer of a material conducting lithium ions, having a porosity of between 35% and 70% by volume, deposited on a metal substrate, and metallic lithium loaded inside the pores of the porous layer, said anode being located inside a lithium-ion battery.

Advantageously, the anode according to the invention does not contain any organic compounds.

Another object of the invention relates to a non-charged lithium-ion battery having a capacity greater than 1 mA h comprising at least one anodic member according to the invention.

Another object of the invention relates to a lithium-ion battery with a capacity greater than 1 mAh, characterized in that it comprises at least one anode according to the invention; the thickness of this anode is advantageously less than 20 μm. The thickness of this anode may also be greater than 20 μm, in particular in the case of high-capacity batteries.

Such a battery advantageously also includes:
a solid electrolyte consisting of nanoparticles of a conductor of lithium ions, which may be of the NASICON type, said nanoparticles being coated with a polymer phase with a thickness of less than 150 nm, preferably less than 100 nm and even more preferentially less than 50 nm, said polymer phase preferably being selected from the group formed by polyethylene oxide, abbreviated to PEO, polypropylene oxide, abbreviated to PPO, polydimethylsiloxane, abbreviated to PDMS, polyacrylonitrile PAN, polymethyl methylmethacrylate, abbreviated to PMMA, polyvinylchloride, abbreviated to PVC, polyvinylidene fluoride, abbreviated to PVDF, polyvinylidene fluoride-co-hexafluoropropylene, polyacrylic acid, abbreviated to PAA; the thickness of this solid electrolyte is preferably less than 20 μm, and even more preferentially less than 10 μm;
a completely solid cathode including a continuous mesoporous lattice of mesoporous lithiated oxide (this continuous lattice is formed by coalescence (necking) of primary nanoparticles), coated with a nanolayer of an electron-conducting material such as carbon; the mesoporosity of this cathode is preferably between 25% and 50% by volume, and it is filled with a phase conducting lithium ions.

In this battery, the capacity per unit surface area of the anode is advantageously greater than that of the cathode.

Said battery is advantageously encapsulated by an encapsulation system that comprises a first layer of polymer followed by a second inorganic insulating layer, this sequence being able to be repeated several times. Said polymer layer can be selected in particular from parylene, type F parylene, polyimide, epoxy resins, polyamide, and/or a mixture of these. Said inorganic layer can be selected in particular from ceramics, glasses, or vitroceramics, which are advantageously deposited by ALD or HDPCVD.

Such a battery advantageously has an energy density per unit volume greater than 900 Wh/liter.

### DRAWINGS

FIGS. 1 to 7 illustrate various aspects of embodiments of the invention, without limiting the scope thereof.

FIG. 1 illustrates schematically nanoparticles before heat treatment.

FIG. 2 illustrates schematically nanoparticles after heat treatment, and in particular the phenomenon of “necking.”

FIG. 3 shows schematically a front view with cutaway of a battery comprising an anodic member/an anode according to the invention and revealing the structure of the battery comprising an assembly of elementary cells covered by an encapsulation system and terminations.

FIG. 4 is a front view with cutaway of a battery, illustrating to a larger scale the detail III of an anodic member disposed on a substrate serving as a current collector.

FIG. 5 is a view in perspective, illustrating a battery according to the invention, which is able to be obtained according to an advantageous variant of the invention.

FIGS. 6A through 6B are views in cross section, along the line XVI-XVI indicated on FIG. 5, illustrating a battery according to the invention, which is able to be obtained in particular according to the method of the preceding figures and the first and second passages of which provided on this battery are filled by conductive means intended to produce the electrical connection between the cells and the battery.

FIG. 7 is a view in cross section illustrating a battery according to the invention that comprises the conductive means intended to produce the electrical connection between the cells and the battery and an encapsulation system.

### DESCRIPTION

### 1. Definitions

In the context of the present invention, the size of a particle is defined by its largest dimension. “Nanoparticle” means any particle or object of nanometric size having at least one of its dimensions less than or equal to 100 nm.

“Ionic liquid” means any electrically insulating liquid salt, able to transport ions, differentiated from all the molten salts by a melting point below 100° C. Some of these salts remain liquid at ambient temperature, such salts are called “ionic liquids at ambient temperature”.

“Mesoporous” materials means any solid that has, within its structure, pores referred to as “mesopores” having a size intermediate between that of micropores (width less than 2 nm) and that of macropores (width greater than 50 nm), namely a size of between 2 nm and 50 nm. This terminology corresponds to that adopted by the IUPAC (cf. “Compendium of Chemical Terminology, Gold Book”, version 2.3.2 (2012 August 19), International Union for Pure and Applied Chemistry), which serves as a reference for a person skilled in the art. The term “nanopore” is therefore not used here, even if the mesopores as defined above have nanometric dimensions within the meaning of the definition of nanoparticles, on the understanding that pores with size less than those of mesopores are referred to by persons skilled in the art as “micropores”, again according to the IUPAC.

A presentation of the concepts of porosity (and of the terminology that has just been disclosed above) is given in the article “Texture des matériaux pulvérulents ou poreux” (Texture of powdery or porous materials) by F. Rouquerol and al., which appeared in the collection “Techniques de l'Ingénieur, Traité Analayse et Caractérisation” (Techniques of the Engineer, Analysis and Characterization Treatise), part P 1050; this article also describes the techniques for characterizing porosity, in particular the BET method.

Within the meaning of the present invention, “mesoporous layer” means a layer that has mesopores. As will be explained below, these mesopores significantly contribute to the total porous volume; this state of affairs is described by the expression “mesoporous layer with a mesoporous porosity greater than X % by volume” used in the description below.

The term “aggregate” signifies, according to the definitions of the IUPAC, a weakly bonded assembly of primary particles. In this case, these primary particles are nanoparticles having a diameter that can be determined by transmission electron microscopy. An aggregate of aggregated primary nanoparticles can normally be destroyed (i.e. reduced to primary nanoparticles) in suspension in a liquid phase under the effect of ultrasound, in accordance with a technique known to persons skilled in the art.

The term “agglomerate” signifies, according to the definitions of the IUPAC, a strongly bonded assembly of primary particles or aggregates.

In the context of the present invention the term “anode” is used to designate the negative electrode, on the understanding that, in a secondary battery, the electrochemical reactions that take place at the electrodes are reversible, and the negative terminal (anode) of the battery can become the cathode when the battery is being recharged.

### 2. Preparation of Suspensions of Nanoparticles of an Electrically Insulating Material that Conducts Lithium Ions

In the context of the present invention, it is preferable not to prepare these suspensions of nanoparticles from dry nanopowders. They can preferentially be prepared by nanogrinding of powders in wet phase. In another embodiment of the invention the nanoparticles are prepared in suspension directly by precipitation. Synthesizing nanoparticles by precipitation makes it possible to obtain primary nanoparticles with a very homogeneous size with a unimodal size distribution, i.e. very close together and monodisperse, of good purity. These primary nanoparticles synthesized by precipitation may show good crystallinity after deposition thereof, or may develop good crystallinity after suitable heat treatment of the layer.

Use of these nanoparticles with a very homogeneous size and narrow distribution makes it possible to obtain, after deposition, a porous layer with controlled open porosity, a porous layer where the pore size is homogeneous, and ultimately to increase the capacity of the anode according to the invention. This is because the capacity of the anode according to the invention depends on the porosity of the porous layer of the anodic member. The greater the porosity of the layer, the more space there will be in the pores of this layer for the subsequent deposition of the lithium. The porous layer obtained after deposition of these nanoparticles has few closed pores and preferably has none. More specifically, the porosity of this layer must be as great as possible, and must be an open porosity; it is this open porosity that provides the electrical continuity of the metallic lithium that is deposited in the porous anodic member during the charging of the battery. Using primary nanoparticles of monodisperse size confers on the porous layer obtained after deposition of these particles a perfectly homogeneous porosity in the host structure as well as a thickness of the solid regions of material conducting lithium ions that is very homogeneous within the host structure. The mean size of the pores in the host structure according to the invention is homogeneous, i.e. the mean value of the size of the pores does not depend on this distance with respect to one of the two interfaces of the porous layer.

This structure makes it possible to avoid having local regions with greater sizes of solid electrolyte particles that may modify the homogeneity of the deposition of the metallic lithium in the structure. The large specific surface area related to the porosity of the host structure according to the invention makes it possible to reduce the current densities during the deposition and during the extraction of the lithium. These low current densities help to limit the losses of capacity during the cycling of the battery. The larger the specific surface area of the host structure, the more homogeneous its porosity and the more highly homogeneous the thickness of the solid regions of material conducting lithium ions within the host structure, the better controlled is the quality and reproducibility of the lithium deposition/extraction process in a host structure according to the invention.

In an even more preferred embodiment of the invention, the nanoparticles are prepared directly at their primary size by hydrothermal or solvothermal synthesis; this technique makes it possible to obtain nanoparticles with a very narrow size distribution, referred to as “monodisperse nanoparticles”. The size of these non-aggregated or non-agglomerated nanopowders/nanoparticles is called the primary size. It is advantageously between 5 nm and 100 nm, preferably between 10 nm and 80 nm; during subsequent method steps this favors the formation of an interconnected mesoporous lattice with ion conduction, by virtue of the phenomenon of “necking” described below.

This suspension of monodisperse nanoparticles can be produced in the presence of organic ligands or stabilizers so as to avoid the aggregation, or even the agglomeration, of the nanoparticles, which makes it possible to best control the size thereof. Adding ligands or stabilizers in the reaction medium, in sufficient quantity, makes it possible to control the level of agglomeration, or even to eliminate the formation of agglomerates.

This suspension of monodisperse nanoparticles can be purified to remove all the potentially interfering ions. According to the degree of purification, it may next be treated specially to form aggregates or agglomerates of a controlled size. More specifically, the formation of aggregates or agglomerates may result from the destabilization of the suspension caused in particular by ions, by increasing the dry extract of the suspension, by changing the solvent of the suspension, or by adding destabilization agents.

If the suspension has not been completely purified, the formation of the aggregates or agglomerates may take place completely on its own spontaneously or by ageing. This way of proceeding is simpler since it involves fewer purification steps, but it is more difficult to control the size of the aggregates or agglomerates. One of the essential aspects for manufacturing anodic members and anodes according to the invention consists of properly controlling the size of the primary particles of the conductive materials of the lithium ions employed and the degree of aggregation or agglomeration thereof.

If the stabilization of the suspension of nanoparticles occurs after the formation of agglomerates, the latter will remain in the form of agglomerates; the suspension obtained will be able to be used for making mesoporous deposits.

It is this suspension of aggregates or agglomerates of nanoparticles that is next used for depositing by electrophoresis, by the inkjet printing method, hereinafter “ink-jet”, by spraying, by flexographic printing, by scraping, hereinafter “doctor blade”, by roll coating, by curtain coating, by slot-die coating, or by dip coating the porous layers, preferably mesoporous, according to the invention.

The porous layer, preferably mesoporous, completely solid, without organic components, of the organic member, also referred to as host structure, is obtained by depositing agglomerates and/or aggregates of nanoparticles of materials conducting lithium ions. The sizes of the primary particles constituting these agglomerates and/or aggregates are of the order of a nanometer or around ten nanometers, and the agglomerates and/or aggregates contain at least 4 primary particles.

Using agglomerates of a few tens or even hundreds of nanometers in diameter rather than primary particles, not agglomerated with each a size of the order of a nanometer or around ten nanometers, makes it possible to increase the deposition thicknesses. The agglomerates advantageously have a size of less than approximately 500 nm. Sintering the agglomerates with a size above this value would not make it possible to obtain a mesoporous continuous film. In this case, two different porosity sizes in the deposition are observed, namely a porosity between agglomerates and a porosity inside the agglomerates.

Using primary nanoparticles with a monodisperse size confers, on the porous layer obtained after deposition of these particles, a homogeneous structure; the size of the pores is homogeneous throughout the host structure (i.e. its mean value does not depend on its distance with respect to one of the two interfaces of the porous layer) and the thickness of the solid regions of material conducting lithium ion very homogeneous throughout the layer of the host structure.

This homogeneous structure is essential; it makes it possible, during subsequent use thereof as an anode, to avoid the formation of dendrites in the porous, preferably mesoporous, layer. Its very large specific surface area considerably reduces the local densities of currents in the anode using this porous layer, which favors nucleation and a homogeneous depositing of the metallic lithium. This is because an anode comprising a porous layer produced from nanoparticles with a mean primary diameter D50 appreciatively greater than 100 nm or having a mean pore diameter greater than 100 nm, can have a great variation in local current density and a high current density; this variation is all the greater when the size distribution of the particles used for producing the porous layer is polydisperse. When the size of the pores is greater than 500 nm, preferably greater than a micrometer, the metallic lithium deposited at the center of the porosity of the porous layer risks remaining “confined” at the center of the porosity during the discharge of the battery. This “confined” lithium does not participate in the charging/discharging cycles of the anode and represents so much loss of capacity in cycling, especially at high currents. During discharges of the battery, the initial lithium re-entering the anode is that located at the surface of the electrode. The more the lithium is, in proximity to the exchange surfaces, in a large quantity, the more reduced is the risk of having “confined” “inactive” lithium. This risk is all the more reduced when the local stripping current density is low. With the large specific surface areas of the anodes according to the invention, the current densities at the interface between the host structure and the lithium are low, but multiplied by the very large surface area of the electrode, this makes it possible, despite everything, to have very powerful batteries.

Moreover, balancing the diffusion resistances in this structure is optimal; there are no risks of locally concentrating the currents or deposits of metallic lithium in the host structure and ultimately degrading the host structure. Moreover, this risk is eliminated by the very large specific surface area that makes it possible to locally reduce the deposition current density. This structure makes it possible to guarantee a diffusion front of the lithium from the interface with this collector towards the solid electrolyte. In the absence of defects, it is indeed the potential gradient that controls the progression front of the lithium in the structure. Although the current densities are reduced at the lithium/host structure interface, the power of the battery is not affected. Quite the contrary, this architecture allows operation at high power.

Moreover, the porous layer of the anodic member according to the invention is electrically insulating; it is the metallic lithium which, in being deposited, will transform this porous layer into an anode; i.e. make this porous layer conductive.

As the porous layer according to the invention is electrically insulating, while it is loaded with metallic lithium a potential gradient is naturally created in the anode. The lithium, being electrically conductive, will thus be deposited in contact with the anodic current collector, where the potential is the lowest. The lithium will thus fill the porosities of the electrode from the interface with the anodic collector in the direction of the interface with the solid electrolyte. This will create, in the anodic structure, a progression front of the lithium from the interface close to the current collector towards the region close to the solid electrolyte.

In order to provide passage of the current, it is important to have a good contact between the lithium deposited and the current collector.

Moreover, as the capacity of our anodes is greater than that of the cathode, the top part of the pores of the host structure of the anode will always remain empty during charging and discharging cycles of the battery comprising such an anode. There are thus no longer any risks of deposition of lithium in the form of dendrites in the solid electrolyte since the solid electrolyte will never be in contact with the metallic lithium.

Moreover, it is observed that, during the drying of the deposits of nanoparticles on a substrate capable of acting as an electric current collector, cracks appear in the layer. It is found that the appearance of these cracks depends essentially on the size of the particles, the compactness of the deposition and the thickness thereof. This limit thickness of cracking is defined by the following equation:

hₘₐₓ=0.41[(GMØ_{rcp}R³)/2γ],

where hₘₐₓ designates the critical thickness, G the shearing modulus of the nanoparticles, M the coordination number, Ø_{rcp} the volume fraction of nanoparticles, R the radius of the particles and y the interface tension between the solvent and air.

As a result the use of mesoporous agglomerates, consisting of primary particles at least ten times smaller than the size of the agglomerate, makes it possible to considerably increase the limit cracking thickness of the layers. In the same way, it is possible to add a few percents of a solvent with a lower surface tension (such as isopropyl alcohol (abbreviated to IPA)) in the water or ethanol in order to improve the wettability and the adhesion of the deposition, and to reduce the risk of cracking. In order to increase the deposition thicknesses while limiting or even eliminating the appearance of cracks, it is possible to add binders or dispersants. These additives and organic solvents can be eliminated by a heat treatment under air, such as by debonding, during a sintering treatment or during a heat treatment implemented prior to the sintering treatment.

Moreover, for the same size of primary particles, it is possible, during synthesis thereof by precipitation, to modify the size of the agglomerates by modulating the quantity of ligands, e.g. polyvinylpyrrolidone, PVP) in the synthesis reactor. It is also possible, after they are synthesized, to add at least one stabilizer in the suspension of nanoparticles, preferably in a concentration by mass of between 5 and 15% for 100% of nanoparticles. Thus, the use of stabilizers advantageously makes it possible to produce an ink containing agglomerates that are homogeneous in size. These stabilizers and binders make it possible to adjust the viscosity of the suspension and the adhesion of the particles so as to optimize the porosity of the deposition of agglomerates and to form a homogeneous deposition in particular by dip coating, using an ink. For an ink with a high dry extract of agglomerates of nanoparticles to be stable, stabilizers are advantageously present around the particles. When the host structure is produced by electrophoresis, the presence of stabilizer is not necessary since the suspension used has in particular a lower dry extract than the ink used by dip coating. The thickness of the deposition obtained by electrophoresis is less.

According to the findings of the applicant, with a mean diameter of aggregates or agglomerates of nanoparticles of less than 500 nm, preferably between 80 nm and 300 nm, a mesoporous layer having a mean diameter of mesopores of between 2 nm and 50 nm is obtained during the subsequent method steps.

The porous layer that constitutes the anodic member according to the invention must be produced from an electrically insulating and ion conducting material, more specifically conducting lithium ions.

Among the materials conducting lithium ions that can be used for producing this porous, preferably mesoporous, layer, materials that are electrochemically stable in contact with metallic lithium will be favored, having low electron conductivity, preferably below 10⁻¹⁰ S/cm and even more preferentially below 10⁻¹¹ S/cm in order to facilitate precipitation of the metallic lithium in contact with the anodic current collector and to create a progression front of the deposition of metallic lithium in the host structure from the interface located close to the current collector towards the separation with the solid electrolyte. These ion-conducting materials used for the mesoporous structure have an ion conductivity greater than 10⁻⁶ S/cm, preferably greater than 10⁻⁵ S/cm, and have relatively low melting points in order to achieve a partial consolidation of the nanoparticles at low temperature.

Among these materials conducting lithium ions, lithiated phosphates are preferred, in particular the lithiated phosphates preferably selected from: the lithiated phosphates of the NaSICON type, Li₃PO₄; LiPO₃; Li₃Al_{0.4}Sc_{1.6}(PO₄)₃ called “LASP”; Li₁₊ₓZr₂₋ₓCaₓ(PO₄)₃ with 0≤x≤0.25; Li₁₊₂ₓZr₂₋ₓCaₓ(PO₄)₃ with 0≤x≤0.25 such as Li_{1.2}Zr_{1.9}Ca_{0.1}(PO₄)₃ or Li_{1.4}Zr_{.8}Ca_{0.2}(PO₄)₃; LiZr₂(PO₄)₃; Li₁₊₃ₓZr₂(P₁₋ₓSiₓO₄)₃ with 1.8<x<2.3; Li₁₋ₓLa_{x/3}Zr₂(PO₄)₃, Li₁₊₆ₓZr₂(P₁₋ₓBₓO₄)₃ with 0≤x≤0.25; Li₃(Sc₂₋ₓMₓ)(PO₄)₃ with M=Al and/or Y and 0≤x≤1; Li₁₊ₓMₓ(Sc)₂₋ₓ(PO₄)₃ with M=Al, Y, Ga or a mixture of these three elements and 0≤x≤0.8; Li₁₊ₓMₓ(Ga_{1-y}Sc_{y})₂₋ₓ(PO₄)₃ with 0≤x≤0.8; 0≤y≤1 and M=Al and/or Y; Li₁₊ₓMₓ(Ga)₂₋ₓ(PO₄)₃ with M=Al and/or Y and 0≤x≤0.8; Li₃+y(Sc₂₋ₓMₓ)Q_{y}P_{3-y}O₁₂ with M=Al and/or Y and Q=Si and/or Se, 0≤x≤0.8 and 0≤y≤1; or Li_{1-x-y}MₓSc₂₋ₓQ_{y}P_{3-y}O₁₂ with M=Al, Y, Ga or a mixture of these three elements and Q=Si and/or Se, 0≤x≤0.8 and 0≤y≤1; or Li_{1+x+y+z}Mₓ(Ga_{1-y}Sc_{y})₂₋ₓQ_{z}P_{3-z}O₁₂ with 0≤x≤0.8, 0≤y≤1, 0≤z≤0.6 with M=Al and/or Y and Q=Si and/or Se; or Li₁₊ₓZr₂₋ₓBₓ(PO₄)₃ with 0≤x≤0.25; or Li₁₊ₓZr₂₋ₓCaₓ(PO₄)₃ with 0≤x≤0.25; or Li₁₊ₓM³ₓM₂₋ₓP₃O₁₂ with 0≤x≤1 and M³=Cr, V, Ca, B, Mg, Bi and/or Mo, M=Sc, Sn, Zr, Hf, Se or Si, or a mixture of these elements.

Use of lithiated phosphates as materials conducting lithium ions makes it possible to reduce the sintering temperature and to facilitate, at low temperature, the partial coalescence of the primary nanoparticles in the aggregates, or agglomerates, and between aggregates or agglomerates.

Other materials conducting lithium ions can be used for producing this porous, preferably mesoporous, layer, in particular lithiated materials, preferably selected from:
the lithiated borates, preferably selected from: Li₃(Sc₂₋ₓMₓ)(BO₃)₃ with M=Al and/or Y and 0≤x≤1; Li₁₊ₓMₓ(Sc)₂₋ₓ(BO₃)₃ with M=Al, Y, Ga or a mixture of these three elements and 0≤x≤0.8; Li₁₊ₓMₓ(Ga_{1-y}Sc_{y})₂₋ₓ(BO₃)₃ with 0≤x≤0.8, 0≤y≤1 and M=Al or Y; Li₁₊ₓMₓ(Ga)₂₋ₓ(BO₃)₃ with M=Al and/or Y and 0≤x≤0.8; Li₃BO₃, Li₃BO₃—Li₂SO₄, Li₃BO₃—Li₂SiO₄, Li₃BO₃—Li₂SiO₄—Li₂SO₄; Li₃Al_{0.4}Sc_{1.6}(BO₃)₃; Li₁₊ₓZr₂₋ₓCaₓ(BO₃)₃ with 0≤x≤0.25; Li₁₊₂ₓZr₂₋ₓCaₓ(BO₃)₃ with 0≤x≤0.25 such as Li_{1.2}Zr_{1.9}Ca_{0.1}(BO₃)₃ or Li_{1.4}Zr_{1.8}Ca_{0.2}(BO₃)₃; LiZr₂(BO₃)₃; Li₁₊₃ₓZr₂(B₁₋ₓSiₓO₃)₃ with 1.8<x<2.3; Li₁₊₆ₓZr₂(P₁₋ₓBₓO₄)₃ with 0<x≤0.25; Li₃(Sc₂₋ₓMₓ)(BO₃)₃ with M=Al and/or Y and 0≤x≤1; Li₁₊ₓMₓ(Sc)₂₋ₓ(BO₃)₃ with M=Al, Y, Ga or a mixture of these three elements and 0≤x≤0.8; Li₁₊ₓMₓ(Ga_{1-y}Sc_{y})₂₋ₓ(BO₃)₃ with 0≤x≤0.8; 0≤y≤1 and M=Al and/or Y; Li₁₊ₓMₓ(Ga)₂₋ₓ(BO₃)₃ with M=Al and/or Y, 0≤x≤0.8; Li_{3+y}(Sc₂₋ₓMₓ)Q_{y}B_{3-y}O₉ with M=Al and/or Y and Q=Si and/or Se, 0≤x≤0.8 and 0≤y≤1; or Li_{1-x-y}MₓSc₂₋ₓQ_{y}B_{3-y}O₉ with M=Al, Y, Ga or a mixture of these three elements and Q=Si and/or Se, 0≤x≤0.8 and 0≤y≤1; or Li_{1+x+y+z}Mₓ(Ga_{1-y}Sc_{y})₂₋ₓQ_{z}B_{3-z}O₉ with 0≤x≤0.8, 0≤y≤1, 0≤z≤0.6 with M=Al and/or Y and Q=Si and/or Se; or Li₁₊ₓZr₂₋ₓBₓ(BO₃)₃ with 0≤x≤0.25; or Li₁₊ₓZr₂₋ₓCaₓ(BO₃)₃ with 0≤x≤0.25; or Li₁₊ₓM³ₓM₂₋ₓ(BO₃)₃ with 0≤x≤1 and M³=Cr, V, Ca, B, Mg, Bi and/or Mo, M=Sc, Sn, Zr, Hf, Se or Si, or a mixture of these elements;
oxynitrides, preferably selected from: Li₃PO₄₋ₓN_{2x/3}, Li₃BO₃₋ₓN_{2x/3} with 0<x<3;
LiₓPO_{y}N_{z} with x˜2.8 and 2y+3z˜7.8 and 0.16≤z≤0.4, and in particular Li_{2.9}PO_{3.3}N_{0.46}, but also the compounds Li_{w}POₓN_{y}S_{z} with 2x+3y+2z=5=w or the compounds Li_{w}POₓN_{y}S_{z} with 3.2 x 3.8, 0.13 y 0.4, 0 z 0.2, 2.9 w 3.3 or the compounds in the form of LiₜPₓAl_{y}OᵤNᵥS, with 5x+3y=5, 2u+3v+2w=5+t, 2.9 t 3.3, 0.84 x 0.94, 0.094 y 0.26, 3.2 u 3.8, 0.13 v 0.46, 0 w 0.2;
materials based on lithium phosphorus or lithium boron oxynitrides, called respectively “LiPON” and “LIBON”, also able to contain silicon, sulfur, zirconium, aluminum, or a combination of aluminum, boron, sulfur and/or silicon, and boron for materials based on lithium phosphorus oxynitrides;
lithiated compounds based on lithium, phosphorus and silicon oxynitride, called “LiSiPON”, and in particular Li_{1.9}Si_{0.28}P_{1.0}O_{1.1}N_{1.0};
lithium oxynitrides of the LiBON, LiBSO, LiSiPON, LiSON, thio-LiSiCON, LiPONB types (where B, P and S represent respectively boron, phosphorus and sulfur);
lithium oxynitrides of the LiBSO type such as (1−x)LiBO₂-xLi₂SO₄ with 0.4 x 0.8;
silicates, preferably selected from Li₂Si₂O₅, Li₂SiO₃, Li₂Si₂O₆, LiAlSiO₄, Li₄SiO₄, LiAlSi₂O₆;
solid electrolytes of the anti-perovskite type selected from: Li₃OA, Li₍₃₋ₓ₎M_{x/2}OA with 0<x 3, M a divalent metal, preferably at least one of the elements selected from Mg, Ca, Ba, Sr or a mixture of two or three or four of these elements, Li₍₃₋ₓ₎M³_{x/3}OA with 0 x 3, M³ a trivalent metal, LiCOX_{Z}Y_{(1-z)}, with X and Y halides as mentioned above in relation to A, and 0 z 1, and where A can be selected from the group formed by a halide or a mixture of halides, preferably at least one of the elements selected from F, Cl, Br, I or a mixture of two or three or four of these elements.

Among the materials conducting lithium ions that can be used for producing this porous, preferably mesoporous, layer, the materials comprising a mixture of lithiated phosphates and lithiated borates will be favored, in particular a mixture comprising:
at least one lithiated phosphate selected from the lithiated phosphates of the NaSICON type, Li₃PO₄; LiPO₃; Li₃Al_{0.4}Sc_{1.6}(PO₄)₃ called “LASP”; Li₁₊ₓZr₂₋ₓCaₓ(PO₄)₃ with 0≤x≤0.25; Li₁₊₂ₓZr₂₋ₓCaₓ(PO₄)₃ with 0≤x≤0.25 such as Li_{1.2}Zr_{1.9}Ca_{0.1}(PO₄)₃ or Li_{1.4}Zr_{1.8}Ca_{0.2}(PO₄)₃; LiZr₂(PO₄)₃; Li₁₊₃ₓZr₂(P₁₋ₓSiₓO₄)₃ with 1.8<x<2.3; Li₁₋ₓLa_{x/3}Zr₂(PO₄)₃, Li₁₊₆ₓZr₂(P₁₋ₓBₓO₄)₃ with 0≤x≤0.25; Li₃(Sc₂₋ₓMₓ)(PO₄)₃ with M=Al and/or Y and 0≤x≤1; Li₁₊ₓMₓ(Sc)₂₋ₓ(PO₄)₃ with M=Al, Y, Ga or a mixture of these three elements and 0≤x≤0.8; Li₁₊ₓMₓ(Ga_{1-y}Sc_{y})₂₋ₓ(PO₄)₃ with 0≤x≤0.8; 0≤y≤1 and M=Al and/or Y; Li₁₊ₓMₓ(Ga)₂₋ₓ(PO₄)₃ with M=Al and/or Y and 0≤x≤0.8; Li_{3+y}(Sc₂₋ₓMₓ)Q_{y}P_{3-y}O₁₂ with M=Al and/or Y and Q=Si and/or Se, 0≤x≤0.8 and 0≤y≤1; or Li_{1-x-y}MₓSc₂₋ₓQ_{y}P_{3-y}O₁₂ with M=Al, Y, Ga or a mixture of these three elements and Q=Si and/or Se, 0≤x≤0.8 and 0≤y≤1; or Li_{1+x+y+z}Mₓ(Ga_{1-y}Sc_{y})₂₋ₓQ_{z}P_{3-z}O₁₂ with 0≤x≤0.8, 0≤y≤1, 0≤z≤0.6 with M=Al and/or Y and Q=Si and/or Se; or Li₁₊ₓZr₂₋ₓBₓ(PO₄)₃ with 0≤x≤0.25; or Li₁₊ₓZr₂₋ₓCaₓ(PO₄)₃ with 0≤x≤0.25; or Li₁₊ₓM³ₓM₂₋ₓP₃O₁₂ with 0≤x≤1 and M³=Cr, V, Ca, B, Mg, Bi and/or Mo, M=Sc, Sn, Zr, Hf, Se or Si, or a mixture of these elements, and
at least one lithiated borate, preferably selected from: Li₃(Sc₂₋ₓMₓ)(BO₃)₃ with M=Al and/or Y and 0≤x≤1; Li₁₊ₓMₓ(Sc)₂₋ₓ(BO₃)₃ with M=Al, Y, Ga or a mixture of these three elements and 0≤x≤0.8; Li₁₊ₓMₓ(Ga_{1-y}Sc_{y})₂₋ₓ(BO₃)₃ with 0≤x≤0.8, 0≤y≤1 and M=Al or Y; Li₁₊ₓMₓ(Ga)₂₋ₓ(BO₃)₃ with M=Al and/or Y and 0≤x≤0.8; Li₃BO₃, Li₃BO₃—Li₂SO₄, Li₃BO₃—Li₂SiO₄, Li₃BO₃—Li₂SiO₄—Li₂SO₄; Li₃Al_{0.4}Sc_{1.6}(BO₃)₃; Li₁₊ₓZr₂₋ₓCaₓ(BO₃)₃ with 0≤x≤0.25; Li₁₊₂ₓZr₂₋ₓCaₓ(BO₃)₃ with 0≤x≤0.25 such as Li_{1.2}Zr_{1.9}Ca_{0.1}(BO₃)₃ or Li_{1.4}Zr_{1.8}Ca_{0.2}(BO₃)₃; LiZr₂(BO₃)₃; Li₁₊₃ₓZr₂(B₁₋ₓSiₓO₃)₃ with 1.8<x<2.3; Li₁₊₆ₓZr₂(P₁₋ₓBₓO₄)₃ with 0≤x≤0.25; Li₃(Sc₂₋ₓMₓ)(BO₃)₃ with M=Al and/or Y and 0≤x≤1; Li₁₊ₓMₓ(Sc)₂₋ₓ(BO₃)₃ with M=Al, Y, Ga or a mixture of these three elements and 0≤x≤0.8; Li₁₊ₓMₓ(Ga_{1-y}Sc_{y})₂₋ₓ(BO₃)₃ with 0≤x≤0.8; 0≤y≤1 and M=Al and/or Y; Li₁₊ₓMₓ(Ga)₂₋ₓ(BO₃)₃ with M=Al and/or Y, 0≤x≤0.8; Li_{3+y}(Sc₂₋ₓMₓ)Q_{y}B_{3-y}O₉ with M=Al and/or Y and Q=Si and/or Se, 0≤x≤0.8 and 0≤y≤1; or Li_{1-x-y}MₓSc₂₋ₓQ_{y}B_{3-y}O₉ with M=Al, Y, Ga or a mixture of these three elements and Q=Si and/or Se, 0≤x≤0.8 and 0≤y≤1; or Li_{1+x+y+z}Mₓ(Ga_{1-y}Sc_{y})₂₋ₓQ_{z}B_{3-z}O₉ with 0≤x≤0.8, 0≤y≤1, 0≤z≤0.6 with M=Al and/or Y and Q=Si and/or Se; or Li₁₊ₓZr₂₋ₓBₓ(BO₃)₃ with 0≤x≤0.25; or Li₁₊ₓZr₂₋ₓCaₓ(BO₃)₃ with 0≤x≤0.25; or Li₁₊ₓM³ₓM₂₋ₓ(BO₃)₃ with 0≤x≤1 and M³=Cr, V, Ca, B, Mg, Bi and/or Mo, M=Sc, Sn, Zr, Hf, Se or Si, or a mixture of these elements.

These materials conducting lithium ions comprising at least one lithiated phosphate and at least one lithiated borate are advantageously used for producing the porous, preferably mesoporous, layer of the anodic member according to the invention. These materials are stable both at the operating potential of the anodes comprising metallic lithium and of the cathodes. The use of this type of material makes it possible to make host structures that are stable over time, and which do not degrade. Moreover, these materials have low melting points and partial coalescence by sintering these materials (hereinafter referred to as the “necking” phenomenon) can be done at relatively low temperature, especially when the particles are nanometric, which represents an additional economic advantage.

Although they have a relatively high electron conductivity, silicates and/or solid electrolytes of the anti-perovskite type can also be used for producing this porous, preferably mesoporous, layer since they are stable over a very wide range of potentials.

By way of example, the materials conducting lithium ions comprising titanium and/or germanium are not stable in contact with lithium; these materials are not used for producing a porous layer according to the invention.

The materials conducting lithium ions employed in the form of nanoparticles and described above are solid electrolytes which, by definition, are electron insulators.

### 3. Deposition of the Layers and Consolidation Thereof

In general terms, a layer of a suspension of nanoparticles is deposited on a substrate, by any suitable technique, and in particular by a method selected from the group formed by: electrophoresis, a printing method and preferably printing by ink jet or flexographic printing, a coating method and preferably with doctor blade, roller, curtain, by dipping, or through a die in the form of a slot. The suspension is typically in the form of an ink, i.e. a fairly fluid liquid, but may also have a viscous consistency. The deposition technique and the conduct of the deposition method must be compatible with the viscosity of the suspension, and vice versa.

The layer deposited will next be dried. The layer can next be consolidated to obtain the mesoporous structure sought. This consolidation will be described below. It can be implemented by heat treatment, by a heat treatment preceded by a mechanical treatment, and optionally by a thermomechanical treatment, typically a thermocompression. During this thermomechanical or heat treatment, the electrode layer will have any organic constituent and residue removed (such as the liquid phase of the suspension of nanoparticles and any surfactant products): it becomes an inorganic layer. The consolidation of a wafer is preferably implemented after separation thereof from its intermediate substrate, since the latter would risk being degraded during this treatment.

The deposition of the layers, and the drying and consolidation thereof, are liable to raise certain problems that will be discussed now. These problems are related partly to the fact that, during the consolidation of the layers, a contraction occurs that causes internal stresses.

### 4. Production of the Porous Structure of the Anodic Member According to the Invention

According to the invention, the porous layer of the anodic member, preferably mesoporous, can be deposited on a substrate. Said substrate may, in a first embodiment, be a substrate capable of acting as an electric current collector, or be in a second embodiment an intermediate temporary substrate that will be explained in more detail below.

According to the invention, the porous layer of the anodic member, preferably mesoporous, can be deposited on a substrate capable of acting as an electric current collector (as described below in the section “Substrate capable of acting as electric current collector”, with a preference for copper, nickel or molybdenum) or on a temporary intermediate substrate.

4.1 Substrate Capable of Acting as Electric Current Collector

In a first embodiment, said substrate is a substrate capable of acting as an electric current collector. Said substrate on which said layer is deposited provides, for the anodic member/anode, the function of current collector. The porous layer of the anodic member can be deposited on one or both of the substrate.

The current collector in the batteries employing anodic members according to the invention must be a metal substrate stable in a range of potentials preferably between 0 V and 3 V with respect to the potential of the lithium and withstanding heat treatments at high temperature. Advantageously, a metal substrate is selected, which may in particular be made from tungsten, molybdenum, chromium, titanium, tantalum, stainless steel or an alloy of two or more of these materials. Such metal substrates are fairly expensive and can greatly increase the cost of the battery. Mo, W, Cr, stainless steel and alloys thereof are particularly well suited. This metal substrate can also be coated with a conductive or semiconductor oxide before depositing the porous layer, which makes it possible in particular to protect less noble substrates such as copper and nickel. Copper and nickel are for their part well suited for operating at the anode and aluminum and titanium at the cathode.

It may be a case of a metal sheet, or a metalized polymer or non-metallic sheet (i.e. coated with a layer of metal). If a metalized polymer sheet is used, the polymer must be selected so as to be able to withstand heat treatments. The substrate is preferably selected from copper, nickel, molybdenum, tungsten, tantalum, chromium, niobium, zirconium or titanium strips, and alloy strips including at least one of these elements. It is also possible to use stainless steel. These substrates have the advantage of being stable in a wide range of potentials and withstanding heat treatments.

Copper, nickel, molybdenum and alloys thereof are preferentially used as substrate of the porous layer of the anodic member. Substrates based on nickel-chrome alloys, stainless steels, chromium, titanium, aluminum, tungsten, molybdenum, tantalum, zirconium, niobium or alloys containing at least one of these elements are preferably used as cathode substrate. These substrates of the porous layer of the anodic member, of the anode and/or of the cathode may be coated or not with a conductive and electrochemically inert deposition. Such coatings can be produced by depositing nitrides, carbides, graphites, gold, palladium and/or platinum.

The thickness of the layer after step (c) is advantageously between approximately 1 μm and approximately 300 μm, preferably between 1 μm and 150 μm, more preferentially between 10 μm and 50 μm, or even between 10 μm and 30 μm. When the substrate employed is a substrate capable of acting as electric current collector, the thickness of the layer after step (c) is limited in order to avoid any problem of cracking.

4.2 Intermediate Substrate

According to a second embodiment, the porous layers are not deposited on a substrate capable of acting as an electric current collector, but on a temporary intermediate substrate.

The porous layer of the anodic member is advantageously deposited on a face of the intermediate substrate, so as to be able subsequently to easily disconnect the porous layer from this intermediate substrate.

In particular, it is possible to deposit, using suspensions with greater concentrations of nanoparticles and/or agglomerates of nanoparticles (i.e. less fluid, preferably viscous), fairly thick layers (called “green sheets”). These thick layers are deposited for example by a coating method, preferably with a blade (a technique known by the term “doctor blade” or “tape casting”) or through a die in the form of a slot (“slot die”). Said intermediate substrate may be a flexible substrate, which may be a polymer sheet, for example polyethylene terephthalate, abbreviated to PET. In this second embodiment, the deposition step is advantageously implemented on a face of said intermediate substrate in order to facilitate the subsequent separation of the layer from its substrate. In this second embodiment, it is possible to separate the layer from its substrate before or after drying, preferably before any heat treatment. The thickness of the layer after drying, during step (c), is advantageously less than or equal to 5 mm, advantageously between approximately 1 μm and approximately 500 μm. The thickness of the drying layer, during step (c), is advantageously less than 300 μm, preferably between approximately 5 μm and approximately 300 μm, preferentially between 5 μm and 150 μm.

In said second embodiment, the method for manufacturing the anodic member for a battery uses an intermediate substrate made from polymer (such as PET) and leads to a so-called “crude strip”. This crude strip is then separated from its substrate; it then forms wafers or sheets (the term “wafer” is hereafter used, whatever its thickness).

These wafers can then be heat treated in order to eliminate the organic constituents. These wafers can be sintered, if necessary, in order to consolidate the nanoparticles until a mesoporous structure is obtained with a porosity of between 35 and 70%, preferably between 45 and 55%. Said porous wafer obtained at step (c) has a thickness advantageously less than or equal to 5 mm, preferably between approximately 1 μm and approximately 500 μm. The thickness of the layer after step (c) is advantageously less than 300 μm, preferably between approximately 5 μm and approximately 300 μm, preferentially between 5 μm and 150 μm.

In a second embodiment an electrically conductive sheet is also provided, covered on both faces with an intermediate thin layer of nanoparticles preferably identical to those constituting the wafer or covered on both faces with a thin layer of conductive glue. Said thin layers preferably have a thickness of less than 1 μm. This sheet may be a metal strip or a graphite sheet.

This electrically conductive sheet is next interposed between two porous wafers obtained previously after the heat treatment of the step c). The assembly is next thermopressed so that said intermediate thin layer of nanoparticles is transformed by sintering and consolidates the porous wafer/substrate/porous wafer assembly to obtain a rigid single-piece subassembly. During this sintering the bond between the porous layer and the intermediate layer is established by diffusion of atoms; this phenomenon is known by the English term “diffusion bonding”. This assembly is done with two porous wafers, preferably produced from the same nanoparticles of at least one electrically insulating material that conducts lithium ions, and the metal sheet disposed between these two porous wafers.

One of the advantages of the second embodiment is that it makes it possible to use inexpensive substrates such as aluminum strips, or copper or graphite strips. This is because these strips do not withstand the consolidation heat treatments of the deposited layers; bonding them to the porous wafers after their heat treatment also makes it possible to avoid oxidation thereof.

According to another variant of the second embodiment, when a porous wafer/substrate/porous wafer assembly is obtained, the lithiophilic coating may then advantageously be deposited on and inside the pores of the porous, preferably mesoporous, wafers of the porous wafer/substrate/porous wafer assembly, as described above, in particular when the porous wafers employed are thick.

This assembly by diffusion bonding can be implemented separately as has just been described, and the anodic member/substrate/anodic member subassemblies thus obtained can be used in manufacturing a battery. This assembly by diffusion bonding can also be implemented by stacking and thermopressing the whole of the structure of the battery; in this case a multilayer stack is assembled comprising a first porous layer of the anodic member according to the invention, its metal substrate, a second porous layer of the anodic member according to the invention, a layer of solid electrolyte, a first cathode layer, its metal substrate, a second cathode layer, a new layer of solid electrolyte, and so on.

More specifically, it is possible either to adhesively bond porous wafers to the two faces of a metal substrate (then the same configuration is found as the one resulting from deposits on the two faces of a metal substrate).

This anodic member/substrate/anodic member subassembly can be obtained by adhesively bonding porous wafers on an electrically conductive sheet capable of subsequently acting as an electric current collector, or by deposition, followed by drying and optionally heat treatment of the layers on a substrate capable of acting as an electric current collector, in particular a metal substrate.

Whatever the embodiment of the anodic member/substrate/anodic member subassembly, the film of electrolyte is next deposited thereon. Next the necessary cuts are made for producing a battery with a plurality of elementary cells, and then the subassemblies are stacked (typically in “head to tail” mode) and thermocompression is implemented for welding the anodic members and cathodes together at the solid electrolyte.

Alternatively, the cuts necessary for producing a battery with a plurality of elementary cells can be made, before a film of electrolyte is deposited, on each subassembly consisting of anodic member/substrate/anodic member and cathode/substrate/cathode. Next the anodic member/substrate/anodic member subassemblies and/or the cathode/substrate/cathode subassemblies are coated with a film of electrolyte, then the subassemblies are stacked (typically in “head to tail” mode) and thermocompression is implemented for welding the anodic members and the cathodes to each other at the film of electrolyte.

In the two variants that have just been presented, the welding by thermocompression is done at a relatively low temperature, which is possible by virtue of the very small size of the nanoparticles. Because of this no oxidation of the metal layers of the substrate is observed.

In other embodiments of the assembly, which will be described below, use is made of a conductive glue (with graphite filler) or a deposit of the sol-gel type containing conductive particles, or metal strips, preferably with a low melting point (for example aluminum); during the thermomechanical treatment (thermopressing) the metal strip may deform by creep and make this weld between the wafers.

When said electrically conductive sheet is metal, it is preferably a laminated sheet, i.e. obtained by rolling. The rolling may optionally be followed by a final annealing, which may be a softening annealing (total or partial) or recrystallization, according to metallurgy terminology. It is also possible to use a sheet deposited electrochemically, for example a sheet of electrodeposited copper or a sheet of electrodeposited nickel.

In all cases, a porous anodic member is obtained, located on either side of a metal substrate serving as an electron current collector.

The porous layer of the anodic member can be deposited electrophoretically, by the dip coating method, by the ink-jet printing method, by spraying, by flexographic printing, by roll coating, by curtain coating, by extrusion coating through a die in the form of a slot (called “slot-die”) or by doctor blade coating, using a suspension comprising aggregates or agglomerates of nanoparticles of material conducting lithium ions, preferably using a concentrated suspension containing agglomerates of nanoparticles. The porous layer is advantageously deposited by the dip coating method or by the slot-die method using a concentrated solution containing agglomerates of monodisperse nanoparticles.

The methods for depositing aggregates or agglomerates of monodisperse nanoparticles electrophoretically, by the dip coating method, by the ink-jet printing method, by roll coating, by curtain coating, by coating of the slot-die type, by spraying, by flexographic printing or by doctor-blade coating are methods that are simple, safe, and easy to implement and to employ on an industrial scale and make it possible to obtain a homogeneous final porous layer. Depositing electrophoretically makes it possible to deposit layers uniformly on a large surface with a high deposition speed. The coating techniques, in particular by dipping, by roll, by slot-die, by curtain and by doctor blade, make it possible to simplify the management of the baths compared with techniques of deposition electrophoretically, since, unlike electrophoresis, the particle content of the bath remains constant during the deposition by coating. Deposition by ink-jet printing makes it possible to make localized deposits in the same way as deposits by doctor blade under mask.

Porous layers in a thick layer can be obtained in a single step by the techniques of roll, curtain, slot-die and doctor-blade coating.

It is possible to deposit aggregates or agglomerates of nanoparticles by a coating method, for example by dipping, whatever the chemical nature of the nanoparticles employed. Coating is the preferred deposition method when the nanoparticles employed are little or not electrically charged. In order to obtain a layer with a required thickness, the step of deposition by dipping the aggregates or agglomerates of nanoparticles followed by the step of drying the layer obtained are repeated as much as necessary.

Although this succession of steps of coating by dipping/drying are time consuming, the deposition method by dip coating is a method that is simple, safe, easy to implement and to apply on an industrial level and makes it possible to obtain a homogeneous and compact final layer.

The layers deposited on the substrates defined above must be dried; the drying must not cause the formation of cracks. The drying is advantageously done under controlled conditions of humidity and temperature.

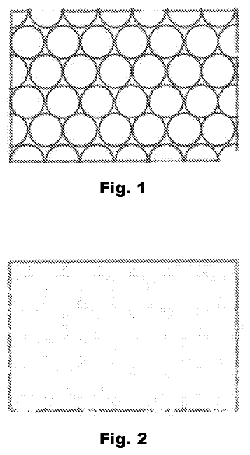

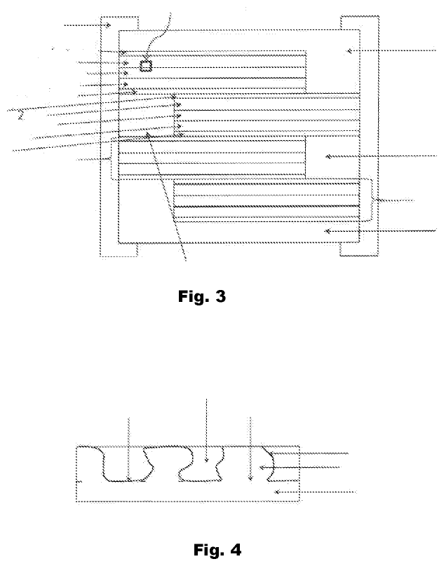

The dried layers can be consolidated by a heat treatment step associated or not with mechanical compression. In a highly advantageous embodiment of the invention this treatment leads to a partial coalescence of the primary nanoparticles in the aggregates or the agglomerates, and between adjacent aggregates or agglomerates; this phenomenon is called “necking” or “neck formation”. It is characterized by the partial coalescence of two particles in contact, which remain separated but connected by a (limited) neck; this is illustrated schematically on FIG. 2. The lithium ions and the electrons are mobile within these necks and can diffuse from one particle to another without encountering grain joints. The nanoparticles are welded together to provide the conduction of the ions from one particle to another. In this way a three-dimensional lattice of interconnected particles with high ionic mobility forms; this lattice includes pores, preferably mesopores.

The nanoparticles are welded together forming a completely ceramic continuous structure, making it possible to ensure passage of the lithium ions throughout the thickness of the electrode, without having to add organic compounds and/or lithium salts. The structure of the anodic member is partially sintered, it no longer shows the concept of particles but rather a concept of porous structure. The nanoparticles are welded together forming a completely ceramic continuous structure, making it possible to ensure the passage of the lithium ions throughout the thickness of the electrode, without having to add organic compounds and/or lithium salts.

The porous layer obtained has a porosity of between 35% and 70% by volume. Such a porosity in the porous layer of the anodic member makes it possible, during the subsequent steps of charging and discharging the anode made from metallic lithium, to avoid variations in volume of the anode. In general terms, anodes made from metallic lithium have a planar exchange surface with the solid electrolyte. This very small exchange surface limits the power of the battery. The architecture of the anode proposed by the applicant comprising a porous layer serving as a host structure, as well as metallic lithium loaded inside the pores of said porous layer, makes it possible to obtain very high power densities related to a very large exchange surface within the anodic member.

The temperature necessary for obtaining partial coalescence of the nanoparticles and consolidation thereof depends on the material; having regard to the diffusive character of the phenomenon that leads to necking, the duration of treatment depends on the temperature. According to the size and the chemical composition of the particles, this consolidation will be implemented either by simple drying, or by drying followed by heat treatment that may or may not be associated with mechanical compression.

Heat treatment also eliminates the adsorbed organic residues resulting from the suspension of nanoparticles employed, such as organic solvents, binders, ligands and/or residual organic stabilizers. Heat treatment also makes it possible to complete the drying of the layer, on the understanding that metallic lithium must precipitate in the mesoporous lattice of the anodic member during charging of the battery is highly reactive with respect to traces of moisture for spontaneously forming LiOH. It is therefore necessary for the drying and heat treatment to be implemented under conditions making it possible to eliminate all the water molecules adsorbed on the surface of the nanoparticles if the deposition was implemented in water, or all traces of organic residues if the deposition was implemented in solvents or if the suspensions in general terms contained organic additives.

To be certain having eliminated all traces of adsorbed water and/or organics, it may be necessary to implement drying/calcination treatment at a temperature that may be as high as 400° C., in air.

If, as will be explained below, subsequently a deposition of a lithiophilic material is implemented on the porous surface of the anodic member, by the atomic layer deposition (ALD) technique, it is necessary first to have eliminated any trace of organic compound. If this layer deposited by ALD covered a layer of organic material, the latter would be interposed between the insertion material of the anodic member and the layer deposited by ALD, and would block the passage of lithium ions. Moreover, the residual organic material would risk polluting the ALD deposition reactor.

Advantageously, the porous layer of the anodic member has a thickness of between 1 μm and 200 μm, preferably between 10 μm and 100 μm. Advantageously, when the porous layer of the anodic member is used in a power lithium-ion battery, i.e. in a battery having a capacity greater than approximately 1 Ah, this porous layer of the anodic member preferably has a thickness of between 20 μm and 150 μm, more preferentially a thickness of approximately 100 μm.

In an advantageous embodiment and in order to guarantee perfect wetting of the lithium in the porous layer during the steps of charging and discharging the battery, a very thin layer of a lithiophilic material is applied, covering, and preferably without defects, on and inside the pores of the porous layer. Thus the accessible surfaces of the porous layer, as well as the accessible parts of the current collectors, are covered with a lithiophilic material, stable in contact with the metallic lithium. The presence of this layer of a lithiophilic material on the surface of the porous layer of the anodic member makes it possible, when the porous layer of the anodic member is obtained using rather lithiophobic and ion conducting materials, i.e. which do not wet the lithium, to limit the strong contact resistance existing between the lithium and the porous layer, to facilitate the reversibility of the lithium insertion/deposition reaction and to reduce the phenomena of growth of metallic lithium dendrites in the most lithiophilic regions such as certain grain joints.

Advantageously, this lithiophilic layer is deposited by the atomic layer deposition (ALD) technique or by chemical solution deposition (CSD), during a step (d) after step (c) of drying the porous layer. More generally, with the techniques for depositing the lithiophilic layer indicated here, a constant thickness of said lithiophilic layer is obtained within the porous, preferably mesoporous, layer. The lithiophilic material may for example be ZnO, Al, Si, CuO.

The lithiophilic layer must be deposited after consolidation, which corresponds to a partial sintering of the nanoparticles obtained by surface diffusion mechanisms. If such a nanolayer is applied to the surfaces of the nanoparticles before consolidation, this sintering risks no longer being possible, or this nanolayer will be located in the weld neck between two particles and prevent diffusion of the lithium ions. Advantageously, the lithiophilic layer is deposited on the accessible surfaces of the porous layer, as well as on the accessible parts of the substrate on which the porous layer is disposed, the substrate having a metallic surface and being able to serve as a current collector. In this case, the lithium is deposited on and inside the pores of the porous layer as well as on the substrate accessible through the pores of the porous layer; this makes it possible to ensure good electrical contact between the anode, when the porous layer comprises metallic lithium in its pores, and the cell of the battery.

This lithiophilic deposition makes it possible to ensure good contact of the metallic lithium on the surface of the porous layer and makes it possible to reduce the polarization resistance, i.e. to guarantee good wettability of the surface of the porous layer by the metallic lithium while reducing the interface resistance existing between the metallic lithium and the electrically insulating material conducting lithium ions of the porous layer, and further improves the performances of the lithium-ion batteries including at least one anode according to the invention. Highly advantageously, this deposition is implemented by a technique making it possible to produce an enrobing coating (also referred to as “conforming deposition”), i.e. a deposition that faithfully reproduces the atomic topography of the substrate on which it is applied. The thickness of this lithiophilic deposition is less than or equal to 10 nm; the thickness of this lithiophilic deposition is homogeneous on and inside the pores of the host structure. In order not to reduce the power of the battery comprising an anodic member according to the invention coated with such a lithiophilic deposition, this lithiophilic deposition must have a very fine and homogeneous thickness. In the case of the porous host structure according to the invention, the thicker the lithiophilic deposition produced on and inside the pores of the host structure, the more considerably reduced becomes the volume making it possible to accommodate the metallic lithium when it is deposited on and in the pores of this porous layer. The ALD (atomic layer deposition) or CSD (chemical solution deposition) technique, known per se, can be used for this deposition. It can be implemented on the porous layers after manufacture, before and/or after the deposition of the separator particles and before and/or after the assembly of the battery. However, the ALD technique cannot be used after assembly of the battery except when the latter is entirely solid. If the cathode is a porous cathode impregnated with a liquid electrolyte, this is not possible.

In a preferred embodiment the deposition of the lithiophilic layer is implemented before the battery is assembled, in particular when the electrolyte and/or the cathode contain organic materials. The lithiophilic layer must be deposited only on surfaces not containing organic binder. This is because deposition by ALD is implemented at a temperature typically between 100° C. and 300° C. At this temperature the organic materials forming the binder (for example the polymers contained in the electrodes produced by ink tape casting) risk decomposing and will pollute the ALD reactor.

The ALD deposition technique is implemented layer by layer, by a cyclic method, and makes it possible to produce a conforming enrobing coating that covers the whole of the surface of the porous layer. The thickness thereof is typically between 0.5 nm and 10 nm. The CSD deposition technique makes it possible also to produce a conforming coating; the thickness thereof is typically less than 10 nm, preferably between 0.5 nm and 5 nm.

By way of example, a layer of ZnO with a thickness of the order of 1 to 5 nm may be suitable. Advantageously, the layer of ZnO covering the surface of the porous layer makes it possible to ensure good wettability between the metallic lithium and the solid electrolyte material serving for producing the porous layer, also serving as a host structure for the metallic lithium.

As illustrated in FIG. 4, the lithiophilic layer 47, 48 applied by ALD or CSD on the porous layer covers only the surface of this porous layer and a part of the surface of the current collector. The porous layer being partially sintered, the lithium ions pass through the weld (the necking) between the particles of the porous layer. The “weld” zone 45 enters the porous layer and the substrate is not covered by the lithiophilic layer.

The lithiophilic layer applied by ALD or CSD covers only the free surfaces of the pores 46, in particular the accessible surfaces of the porous layer 22 and those of the substrate 21.

In addition, the lithiophilic deposits made by ALD or CSD are particularly effective. They are certainly thin, but completely covering, without defects.

In general terms, the method according to the invention, which necessarily involves a step of depositing nanoparticles of material conducting lithium ions, means that the nanoparticles “weld” to each other naturally or under heat treatment to generate a three-dimensional rigid porous structure without organic binder; this porous, preferably mesoporous, layer is perfectly well suited to the application of a surface treatment by ALD that enters the depth of the open porous structure of the layer.

On the porous, preferably mesoporous, layers coated or not with a lithiophilic layer by ALD or by CSD, it is possible to deposit a layer of a solid electrolyte in order to produce a battery cell.

### 5. Manufacture of Batteries Using the Anodic Members According to the Invention

The porous layers according to the invention, coated or not with a lithiophilic layer, can be used as anodic members of a battery.

The batteries using such anodic members or such anodes according to the invention cannot be impregnated by liquid electrolytes. Impregnating the porous layer of the anode according to the invention would prevent the “plating” of the lithium in the porosities, and the structure would no longer be able to function as an anode.

5.1 Cathodes that can be Used in Batteries According to the Invention

The cathodes used in such batteries may be layers of the “completely solid” type, i.e. devoid of impregnated liquid or viscous phases (said liquid or viscous phases being able to be a medium conducting lithium ions, capable of acting as electrolyte). These cathodes can in particular be obtained in a thin layer by PVD or CVD deposition and be dense, i.e. have a porosity of less than 15% by volume, or by sintering powders of cathode materials.

The cathodes used in such batteries may also be:
layers of the mesoporous “completely solid” type, impregnated by a liquid or viscous phase, typically a medium conducting lithium ions, which spontaneously enters inside the layer and which no longer emerges from this layer, so that this layer can be considered to be quasi-solid, or
impregnated porous layers (i.e. layers having a lattice of open pores that can be impregnated with a liquid or viscous phase, and which confers wet properties on these layers).

They can be deposited by several techniques and preferentially by the ink-jet printing method, by doctor blade, by coating of the slot-die type, electrophoretic deposition or by other deposition techniques known to persons skilled in the art allowing the use of a suspension of nanoparticles.

The mean size of these nanoparticles of cathode materials is preferably less than 100 nm, preferentially less than 50 nm.

These cathodes may comprise electron conductors such as graphite, or metal nanoparticles, polymers conducting lithium ions, these polymers being able to contain lithium salts for providing the ion conductivity in the cathode.

The cathode materials are preferably selected from:
the following oxides LiMn₂O₄, Li₁₊ₓMn₂₋ₓO₄ with 0<x<0.15, LiCoO₂, LiNiO₂, LiMn_{1.5}Ni_{0.5}O₄, LiMn_{1.5}Ni_{0.5-X}XₓO₄ where X is selected from Al, Fe, Cr, Co, Rh, Nd, other rare earths such as Sc, Y, Lu, La, Ce, Pr, Pm, Sm, Eu, Gd, Tb, Dy, Ho, Er, Tm, Yb, and where 0<x<0.1, LiMn₂₋ₓMₓO₄ with M=Er, Dy, Gd, Tb, Yb, Al, Y, Ni, Co, Ti, Sn, As, Mg or a mixture of these elements and where 0<x<0.4, LiFeO₂, LiMn_{1/3}Ni_{1/3}Co_{1/3}O₂, LiNi_{0.8}Co_{0.15}Al_{0.05}O₂, LiAlₓMn₂₋ₓO₄ with 0≤x<0.15, LiNi_{1/x}Co_{1/y}Mn_{1/z}O₂ with x+y+z=10, LiNi_{1/x}Co_{1/y}Mn_{1/z}Al_{1/w}O₂ with x+y+z+w=10 and more particularly LiNi_{0.4}Mn_{0.4}Co_{0.14}Al_{0.05}O₂;
LiₓM_{y}O₂ where 0.6≤y≤0.85; 0≤x+y≤2; and M is selected from Al, Ti, Cr, Mn, Fe, Co, Ni, Cu, Zn, Zr, Nb, Mo, Ru, Sn, and Sb or a mixture of these elements; Li_{1.20}Nb_{0.20}Mn_{0.60}O₂;
Li₁₊ₓNb_{y}Me_{z}AₚO₂ where Me is at least a transition metal selected from: Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, Rf, db, Sg, Bh, Hs and Mt, and where 0.6<x<1; 0<y<0.5; 0.25≤z<1; with A≠Me and A≠Nb, and 0≤p≤0.2;
LiₓNb_{y-a}NₐM_{z-b}P_{b}O_{2-c}F_{c} where 1.2<x≤1.75; 0≤y<0.55; 0.1<z<1; 0≤a<0.5; 0≤b<1; 0≤c<0.8; and where M, N, and P are each at least one of the elements selected from the group consisting of Ti, Ta, V, Cr, Mn, Fe, Co, Ni, Cu, Zn, Al, Zr, Y, Mo, Ru, Rh, and Sb;
Li_{1.25}Nb_{0.25}Mn_{0.50}O₂; Li_{1.3}Nb_{0.3}Mn_{0.40}O₂; Li_{1.3}Nb_{0.3}Fe_{0.40}O₂; Li_{1.3}Nb_{0.43}Ni_{0.27}O₂; Li_{1.3}Nb_{0.43}Co_{0.27}O₂; Li_{1.4}Nb_{0.2}Mn_{0.53}O₂;
LiₓNi_{0.2}Mn_{0.6}O_{y} where 0.00≤x≤1.52; 1.07≤y<2.4; Li_{1.2}Ni_{0.2}Mn_{0.6}O₂;
LiNiₓCo_{y}Mn_{1-x-y}O₂ where 0≤x and y≤0.5; LiNiₓCe_{z}Co_{y}Mn_{1-x-y}O₂ where 0≤x and y≤0.5 and 0≤z;
the phosphates LiFePO₄, LiMnPO₄, LiCoPO₄, LiNiPO₄, Li₃V₂(PO₄)₃; Li₂MPO₄F with M=Fe, Co, Ni or a mixture of these various elements, LiMPO₄F with M=V, Fe, T or a mixture of these various elements; the phosphates of formula LiM₁₋ₓM′ₓPO₄, with M and M′ (M≠M′) selected from Fe, Mn, Ni, Co, V such as LiFeₓCo₁₋ₓPO₄ and where 0<x<1;
all the lithiated forms of the following chalcogenides: V₂O₅, V₃O₈, TiS₂, the titanium oxysulfides (TiO_{y}S_{z} with z=2−y and 0.3≤y≤1), the tungsten oxysulfides (WO_{y}S_{z} with 0.6<y<3 and 0.1<z<2), CuS, CuS₂, preferably LiₓV₂O₅ with 0<x≤2, LiₓV₃O₈ with 0<x≤1.7, LiₓTiS₂ with 0<x≤1, the titanium and lithium oxysulfides LiₓTiO_{y}S_{z} with z=2−y, 0.3≤y≤1 and 0<x≤1, LiₓWO_{y}S_{z} with z=2−y, 0.3≤y≤1 and 0<x≤1, LiₓCuS with 0<x≤1, LiₓCuS₂ with 0<x≤1;
the fluorophosphates LiMPO₄F with M=V, Fe, T, Co; Li₂M′PO₄F with M′=Fe, Co, Ni; LiₓNa₁₋ₓVPO₄F;
the fluorosulfates: LiMSO₄F with M=Fe, Co, Ni, Mn, Zn, Mg;
the oxyfluorides of type Fe_{0.9}Co_{0.1}OF; LiMSO₄F with M=Fe, Co, Ni, Mn, Zn, Mg.

5.2 Electrolytes that can be Used in Batteries According to the Invention

In general terms, in the context of the present invention, the solid electrolyte layer is deposited on the face of the anodic member and/or of the cathode. The layer of electrolyte must be dense. The use of nanoparticles functionalized by a polymer coating makes it possible to block the propagation of lithium dendrites in the electrolyte; these layers can be electrochemically stable in contact both with lithium anodes and cathodes operating at more than 4 V.

The solid electrolyte layers employed in a battery comprising anodic members and anodes according to the invention are advantageously produced from solid electrolyte materials:
having an electron conductivity of less than 10⁻¹ S/cm, preferably less than 10⁻¹¹ S/cm to limit the risk of subsequent formation of lithium dendrites,
electrochemically stable in contact with metallic lithium and at the operating potential of the cathodes,
having an ion conductivity greater than 10⁻⁶ S/cm, preferably greater than 10⁻⁵ S/cm,
having a good quality of ionic contact with the porous layer of the anodic member that will subsequently serve as anode when it is loaded with metallic lithium, and
having a relatively low melting point in order to achieve partial consolidation of the nanoparticles at low temperature.

The structure of the electrolyte defines the battery assembly conditions.

In the case where particles of electrolyte material coated with a layer of polymer is used, assembling this electrolyte by thermocompression must be done at a temperature compatible with said polymers; these are then the layers of polymer that will weld together the particles.

Advantageously, the layer of solid electrolyte is deposited by any suitable means on the anodic member coated or not according to the invention and/or on the cathode. This layer of electrolyte must be dense in order to avoid any deposition of metallic lithium in this layer.

These advantages are explained in greater detail in section 10 below, the layer of solid electrolyte is produced from core/shell particles comprising as core a particle of a material serving as an electrolyte on which a shell comprising a polymer is grafted, as will be explained below in section 5.2.1. The emblematic and preferred example of this polymer is PEO, which here can always be replaced by another polymer selected from the list given below.

The core of the core/shell particles is advantageously a solid electrolyte material and/or a ceramic. Advantageously, the layer of solid electrolyte comprises a solid electrolyte and PEO or another of the polymers listed. Advantageously, the layer of solid electrolyte comprises a solid electrolyte and polymer in a solid electrolyte/polymer ratio by volume greater than 35%, preferably greater than 50% and even more preferentially greater than 70%.

The nanoparticles of electrolyte can be produced by nanogrinding/dispersion of a solid electrolyte powder or by hydrothermal synthesis or by solvothermal synthesis or by precipitation.

5.2.1 Functionalization of the Nanoparticles of Material that can Serve as Electrolyte by a Polymer

The nanoparticles of electrolyte, which are inorganic, can next be functionalized with organic molecules in a liquid phase, in accordance with methods known to a person skilled in the art. The functionalization consists of grafting on the surface of the nanoparticles a molecule having a structure of the Q-Z type in which Q is a function providing the attachment of the molecule to the surface, and Z is a polymer group.

In the context of the present invention, said polymer must be ion conducting (and in particular lithium ions, on the understanding that the lithium ion is the smallest of the ions of a metal), and must be an electron insulator. Polymers that are particularly well suited for implementing the present invention are polyethylene oxide, abbreviated to PEO, polypropylene oxide, abbreviated to PPO, polydimethylsiloxane, abbreviated to PDMS, polyacrylonitrile, abbreviated to PAN, polymethylmethacrylate, abbreviated to PMMA, polyvinylchloride, abbreviated to PVC, polyvinylidene fluoride, abbreviated to PVDF, polyvinylidene fluoride-co-hexafluoropropylene, polyacrylic acid, abbreviated to PAA.

The majority of polymers, and in particular those cited above, exhibit neither electron conductivity nor ion conductivity. To make these polymers ion conductive, there are several methods available. It is possible to dissolve lithium salts in the polymer, it is possible to add liquid electrolytes to the polymer to make a gel thereof, or it is possible to add conductive nanoparticles to the polymer; the latter embodiment is particularly advantageous. It is also possible to use as a polymer the shell of the core-shell nanoparticles, a grafted polymer including ion groups having lithium ions Li+ or a grafted polymer including OH groups the hydrogen of which has, at least partly, preferably completely, been substituted by lithium. This substitution can be implemented by simple immersion of the core-shell particles including on the surface OH groups in a solution of LiOH at 80° C. for 8 h.

We describe here an embodiment of the functionalization of nanoparticles by a polymer. In this embodiment, the functionalization consists of grafting on the surface of the nanoparticles a molecule having a structure of the Q-Z type in which Q is a function providing the attachment of the molecule to the surface, and Z is in general terms a polymer, preferably selected from PEO, PPO, PDMS, PAN, PMMA, PVC, PVDF, PAA, polyvinylidene fluoride-co-hexafluoropropylene, and in this example a PEO group.

As Q group, a function complexing the surface cations of the nanoparticles can be used such as the phosphate or phosphonate function.

Preferably, the nanoparticles of electrolyte are functionalized by a PEO derivative of the type:

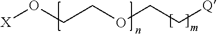

where X represents an alkyl chain or a hydrogen atom, n is between 40 and 10,000 (preferably between 50 and 200), m is between 0 and 10, and Q′ is an embodiment of Q and represents a group selected from the group formed by:

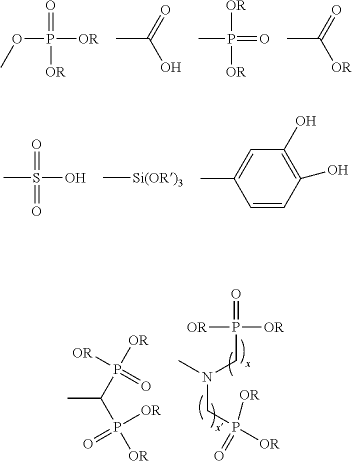

and where R represents an alkyl chain or a hydrogen atom, R′ represents a methyl group or an ethyl group, x is between 1 and 5, and x′ is between 1 and 5.

More preferably, the nanoparticles of electrolyte are functionalized by methoxy-PEO-phosphonate:

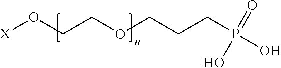

where n is between 40 and 10,000 and preferably between 50 and 200.

According to an advantageous embodiment, a solution of Q-Z (or Q′-Z, where applicable) is added to a colloidal suspension of nanoparticles of electrolyte so as to obtain a molar ratio between Q (which here comprises Q′) and all the cations present in the nanoparticles of electrolyte (abbreviated here to “NP-E”) of between 1 and 0.01, preferably between 0.1 and 0.02. Beyond a Q/NP-E molar ratio of 1, the functionalization of the nanoparticles of electrolyte by the Q-Z molecule risks causing a steric hindrance such that the particles of electrolyte cannot be completely functionalized; this also depends on the size of the particles. For a Q/NP-E-molar ratio of less than 0.01, the Q-Z molecule risks not being in sufficient quantity to provide sufficient conductivity of the lithium ions; this also depends on the size of the particles. The use of a greater quantity of Q-Z during the functionalization would cause an unnecessary consumption of Q-Z.

5.2.2 Control of the Granulometry

The layer of electrolyte is advantageously a dense layer. To obtain a final porosity level of less than 15%, preferably less than 10%, on layers produced on metal substrates without cracks, it is necessary to maximize the compactness of the initial deposition of nanoparticles.

In an advantageous embodiment of the invention, for depositing the layer of electrolyte, colloidal suspensions of nanoparticles are used where the mean size of the particles do not exceed 100 nm. These nanoparticles moreover have a fairly spread-out size distribution. When this size distribution follows approximately Gaussian distribution, then the ratio (sigma/Rₘₑₐₙ) of the standard deviation to the mean radius of the nanoparticles must be greater than 0.6.

To increase this compactness of the initial deposition before consolidation by thermocompression, it is also possible to use a mixture of two size populations of nanoparticles. In this case, the mean diameter of the largest distribution should not exceed 100 nm, and preferably not exceed 50 nm. This first population of the coarsest nanoparticles may have a tighter size distribution with a sigma/Rₘₑₐₙ ratio of less than 0.6. This population of “coarse” nanoparticles will have to represent between 50% and 75% of the dry extract of the deposit (expressed as a mass percentage with respect to the total mass of nanoparticles in the deposit). The second population of nanoparticles will consequently represent between 50% and 25% of the dry extract of the deposit (expressed as a mass percentage with respect to the total mass of nanoparticles in the deposit). The mean diameter of the particles of this second population will have to be at least 5 times smaller than that of the population of coarsest nanoparticles. As with the coarsest nanoparticles, the size distribution of this second population can be tighter and with potentially a sigma/Rₘₑₐₙ ratio of less than 0.6.

In all cases, the two populations will not have to exhibit any agglomeration in the ink produced. Thus, these nanoparticles can advantageously be synthesized in the presence of organic ligands or stabilizers so as to avoid the aggregation or even the agglomeration of the nanoparticles.

Preparing the colloidal suspensions by wet nanogrinding makes it possible to obtain fairly wide size distributions. However, according to the nature of the material ground, its “fragility” and the degree of reduction applied, the primary nanoparticles may be damaged or amorphized.

The materials used in manufacturing lithium-ion batteries are particularly sensitive, the least modification of their crystalline state or of their chemical composition results in degraded electrochemical performances. Thus, for this type of application, it is preferable to use nanoparticles prepared in suspension directly by precipitation, according to methods of the solvothermal or hydrothermal type, at the primary nanoparticle size required.

These methods for synthesizing nanoparticles by precipitation make it possible to obtain primary nanoparticles of homogeneous size with a small size distribution, and good crystallinity and purity. It is also possible to obtain, with these methods, very small particle sizes, which may be less than 10 nm, and in a non-aggregated state. For this purpose, it is necessary to add a ligand directly to the synthesis reactor so as to avoid the formation of agglomerates or aggregates during the synthesis. By way of example, PVP can be used for fulfilling this function.

As the size distribution of the non-agglomerated nanoparticles obtained by precipitation is fairly tight, it is necessary to privilege a strategy for producing colloidal suspension mixing two size distributions in accordance with the rules described previously in order to maximize the compactness of the deposition before sintering. This will make it possible, after sintering, to produce relatively thick deposits, directly on metal substrates with little or no risk of cracking during the sintering heat treatment, which for its part will be maintained at a relatively low temperature because of the small size of the nanoparticles used.

5.2.3 Selection of the Electrolyte Material

Whatever the polymer, the nanoparticles of electrolyte are advantageously selected from:
the lithiated phosphates of the NaSICON type, Li₃PO₄; LiPO₃; Li₃Al_{0.4}Sc_{1 6}(PO₄)₃ called “LASP”; Li_{1.2}Zr_{1.9}Ca_{0.1}(PO₄)₃; LiZr₂(PO₄)₃; Li₁₊₃ₓZr₂(P₁₋ₓSiₓO₄)₃ with 1.8<x<2.3; Li₁₊₆ₓZr₂(P₁₋ₓBₓO₄)₃ with 0≤x≤0.25; Li₃(Sc₂₋ₓMₓ)(PO₄)₃ with M=Al and/or Y and 0≤x≤1; Li₁₊ₓMₓ(Sc)₂₋ₓ(PO₄)₃ with M=Al, Y, Ga or a mixture of the three elements and 0≤x≤0.8; Li₁₊ₓMₓ(Ga_{1-y}Sc_{y})₂₋ₓ(PO₄)₃ with 0≤x≤0.8; 0≤y≤1 and M=Al and/or Y; Li₁₊ₓMₓ(Ga)₂₋ₓ(PO₄)₃ with M=Al and/or Y and 0≤x≤0.8; Li₃+y(Sc₂₋ₓMₓ)Q_{y}P_{3-y}O₁₂ with M=Al and/or Y and Q=Si and/or Se, 0≤x≤0.8 and 0≤y≤1; or Li_{1+x+y}MₓSc₂₋ₓQ_{y}P_{3-y}O₁₂ with M=Al, Y, Ga or a mixture of these elements and Q=Si and/or Se, 0≤x≤0.8 and 0≤y≤1; or Li_{1+x+y+z}Mₓ(Ga_{1-y}Sc_{y})₂₋ₓQ_{Z}P_{3-z}O₁₂ with 0≤x≤0.8, 0≤y≤1, 0≤z≤0.6 with M=Al and/or Y and Q=Si and/or Se; or Li₁₊ₓZr₂₋ₓBₓ(PO₄)₃ with 0≤x≤0.25; or Li₁₊ₓZr₂₋ₓCaₓ(PO₄)₃ with 0≤x≤0.25; or Li₁₊ₓM³ₓM₂₋ₓP₃O₁₂ with 0≤x≤1 and M³=Cr, V, Ca, B, Mg, Bi and/or Mo, M=Sc, Sn, Zr, Hf, Se or Si, or a mixture of these elements.
lithiated borates, preferably selected from: Li₃(Sc₂₋ₓMₓ)(BO₃)₃ with M=Al or Y and 0≤x≤1; Li₁₊ₓMₓ(Sc)₂₋ₓ(BO₃)₃ with M=Al, Y, Ga or a mixture of the three elements and 0≤x≤0.8; Li₁₊ₓMₓ(Ga_{1-y}Sc_{y})₂₋ₓ(BO₃)₃ with 0≤x≤0.8, 0≤y≤1 and M=Al and/or Y; Li₁₊ₓMₓ(Ga)₂₋ₓ(BO₃)₃ with M=Al and/or Y and 0≤x≤0 8; Li₃BO₃, Li₃BO₃—Li₂SO₄, Li₃BO₃—Li₂SiO₄, Li₃BO₃—Li₂SiO₄—Li₂SO₄; Li₃Al_{0.4}Sc_{1.6}(BO₃)₃; Li₁₊ₓZr₂₋ₓCaₓ(BO₃)₃ with 0≤x≤0.25; Li₁₊₂ₓZr₂₋ₓCaₓ(BO₃)₃ with 0≤x≤0.25 such as Li_{1.2}Zr_{1.9}Ca_{0.1}(BO₃)₃ or Li_{1.4}Zr_{1.8}Ca_{0.2}(BO₃)₃; LiZr₂(BO₃)₃; Li₁₊₃ₓZr₂(B₁₋ₓSiₓO₃)₃ with 1.8<x<2.3; Li₁₊₆ₓZr₂(P₁₋ₓBₓO₄)₃ with 0<x≤0.25; Li₃(Sc₂₋ₓMₓ)(BO₃)₃ with M=Al and/or Y and 0≤x≤1; Li₁₊ₓMₓ(Sc)₂₋ₓ(BO₃)₃ with M=Al, Y, Ga or a mixture of these three elements and 0≤x≤0.8; Li₁₊ₓMₓ(Ga_{1-y}Sc_{y})₂₋ₓ(BO₃)₃ with 0≤x≤0.8; 0≤y≤1 and M=Al and/or Y; Li₁₊ₓMₓ(Ga)₂₋ₓ(BO₃)₃ with M=Al and/or Y, 0≤x≤0.8; Li_{3+y}(Sc₂₋ₓMₓ)Q_{y}B_{3-y}O₉ with M=Al and/or Y and Q=Si and/or Se, 0≤x≤0.8 and 0≤y≤1; or Li_{1-x-y}MₓSc₂₋ₓQ_{y}B_{3-y}O₉ with M=Al, Y, Ga or a mixture of these three elements and Q=Si and/or Se, 0≤x≤0.8 and 0≤y≤1; or Li_{1+x+y+z}Mₓ(Ga_{1-y}Sc_{y})₂₋ₓQ_{z}B_{3-z}O₉ with 0≤x≤0.8, 0≤y≤1, 0≤z≤0.6 with M=Al and/or Y and Q=Si and/or Se; or Li₁₊ₓZr₂₋ₓBₓ(BO₃)₃ with 0≤x≤0.25; or Li₁₊ₓZr₂₋ₓCaₓ(BO₃)₃ with 0≤x≤0.25; or Li₁₊ₓM³ₓM₂₋ₓ(BO₃)₃ with 0≤x≤1 and M³=Cr, V, Ca, B, Mg, Bi and/or Mo, M=Sc, Sn, Zr, Hf, Se or Si, or a mixture of these elements;
oxynitrides, preferably selected from Li₃PO₄₋ₓN_{2x/3}, Li₃BO₃₋ₓN_{2x/3} with 0<x<3;
LiₓPO_{y}N_{z} with x˜2.8 and 2y+3z˜7.8 and 0.16 z 0.4, and in particular Li_{2.9}PO_{3.3}N_{0.46}, but also the compounds Li_{w}POₓN_{y}S_{z} with 2x+3y+2z=5=w or the compounds Li_{w}POₓN_{y}S_{z} with 3.2 x 3.8, 0.13 y 0.4, 0 z 0.2, 2.9 w 3.3 or the compounds in the form of LiₜPₓAl_{y}OᵤNᵥS, with 5x+3y=5, 2u+3v+2w=5+t, 2.9 t 3.3, 0.84 x 0.94, 0.094 y 0.26, 3.2 u 3.8, 0.13 v 0.46, 0 w 0.2;
the materials based on lithium phosphorus oxynitrides or lithium boron oxynitrides, called respectively “LiPON” and “LIBON”, which may also contain silicon, sulfur, zirconium, aluminum, or a combination of aluminum, boron, sulfur and/or silicon, and boron for materials based on lithium phosphorus oxynitrides;
lithiated compounds based on lithium, phosphorus and silicon oxynitride called “LiSiPON”, and in particular Li_{1.9}Si_{0.28}P_{1.0}O_{1.1}N_{1.0};
lithium oxynitrides of the following types: LiBON, LiBSO, LiSiPON, LiSON, thio-LiSiCON, LiPONB (where B, P and S represent respectively boron, phosphorus and sulfur);
lithium oxides of the LiBSO type such as (1−x)LiBO₂-xLi₂SO₄ with 0.4 x 0.8;
silicates, preferably selected from Li₂Si₂O₅, Li₂SiO₃, Li₂Si₂O₆, LiAlSiO₄, Li₄SiO₄, LiAlSi₂O₆;
solid electrolytes of the anti-perovskite type selected from: Li₃OA with A a halide or a mixture of halides, preferably at least one of the elements selected from F, Cl, Br, I or a mixture of two or three or four of these elements; Li₍₃₋ₓ₎M_{x/2}OA with 0<x 3, M a divalent metal, preferably at least one of the elements selected from Mg, Ca, Ba, Sr or a mixture of two or three or four of these elements, A a halide or a mixture of halides, preferably at least one of the elements selected from F, Cl, Br, I or a mixture of two or three or four of these elements; Li₍₃₋ₓ₎M³_{x/3}OA with 0 x 3, M³ a trivalent metal, A a halide or a mixture of halides, preferably at least one of the elements selected from F, Cl, Br, I or a mixture of two or three or four of these elements; or LiCOX_{Z}Y_{(1-z)}, with X and Y halides as mentioned above in relation to A, and 0 z 1.

As electrolyte, use will preferably be made of a material selected from those cited above since they are stable, as they stand, in contact with metallic lithium and cathodes.

As core of core/shell particles, use can also be made of an electrolyte material that is less stable in contact with metallic lithium, such as a material selected from the group formed by:
garnets of formula Li_{d} A¹ₓ A²_{y}(TO₄)_{z} where A¹ represents a cation with a degree of oxidation +II, preferably Ca, Mg, Sr, Ba, Fe, Mn, Zn, Y, Gd; and where A² represents a cation with a degree of oxidation +III, preferably Al, Fe, Cr, Ga, Ti, La; and where (TO₄) represents an anion wherein T is an atom with a degree of oxidation +IV, located at the center of a tetrahedron formed by the oxygen atoms, and wherein TO₄ advantageously represents the silicate or zirconate anion, on the understanding that all or some of the elements T with a degree of oxidation +IV can be replaced by atoms with a degree of oxidation +III or +V, such as Al, Fe, As, V, Nb, In, Ta; on the understanding that: d is between 2 and 10, preferentially between 3 and 9, and even more preferentially between 4 and 8; x is to be between 2.6 and 3.4 (preferably between 2.8 and 3.2); y is between 1.7 and 2.3 (preferably between 1.9 and 2.1) and z is between 2.9 and 3.1;
garnets, preferably selected from: Li₇La₃Zr₂O₁₂; Li₆La₂BaTa₂O₁₂; Li_{5.5}La₃Nb_{1.75}In_{0.25}O₁₂; Li₅La₃M₂O₁₂ with M=Nb or Ta or a mixture of the two compounds; Li₇₋ₓBaₓLa₃₋ₓM₂O₁₂ with 0≤x≤1 and M=Nb or Ta or a mixture of the two compounds; Li₇₋ₓLa₃Zr₂₋ₓMₓO₁₂ with 0≤x≤2 and M=Al, Ga or Ta or a mixture of two or three of these compounds;
lithiated oxides, preferably selected from Li₇La₃Zr₂O₁₂ or Li_{5+X}La₃(Zrₓ,A₂₋ₓ)O₁₂ with A=Sc, Y, Al, Ga and 1.4 x 2 or Li_{0.35}La_{0.55}TiO₃ or Li₃ₓLa_{2.3-x} TiO₃ with 0 x 0.16 (LLTO);
the compounds La_{0.51}Li_{0.34}Ti_{2.94}, Li_{3.4} V_{0.4}Ge_{0.6}O₄, Li₂O—Nb₂O₅, LiAlGaSPO₄;
the formulations based on Li₂CO₃, B₂O₃, Li₂O, Al(PO₃)₃LiF, P₂S₃, Li₂S, Li₃N, Li₁₄Zn(GeO₄)₄, Li_{3.6} Ge_{0.6}V_{0.4}O₄, LiTi₂(PO₄)₃, Li_{3.25}Ge_{0.25}P_{0.25}S₄, Li_{1.3}Al_{0.3}Ti_{1.7}(PO₄)₃, Li₁₊ₓAlₓM₂₋ₓ(PO₄)₃(where M=Ge, Ti, and/or Hf, and where 0<x<1), Li_{1+x+y}AlₓTi₂₋ₓSi_{y}P_{3-y}O₁₂ (where 0≤x≤1 and 0≤y≤1).

Using a polymer at the contact interface between the solid electrolyte materials of the layer of electrolyte and the electrodes, protects these electrodes from any degradation. These polymer shells, disposed around these nanoparticles of electrolyte material, which are less stable in contact with metallic lithium, will protect these nanoparticles from any degradations that they might suffer in contact with the electrodes.

A colloidal suspension of nanoparticles of electrolyte at a mass concentration of between 0.1% and 50%, preferably between 5% and 25%, and even more preferentially at 10%, is used for implementing the functionalization of the particles of electrolyte. At a high concentration there may be a risk of bridging and a lack of accessibility of the surface to be functionalized (a risk of precipitation of particles that are not or poorly functionalized). Preferably, the nanoparticles of electrolyte are dispersed in a liquid phase such as water or ethanol.

This reaction can be implemented in all suitable solvents making it possible to solubilize the Q-Z molecule.

According to the Q-Z molecule, the functionalization conditions can be optimized, in particular by adjusting the temperature and duration of the reaction, and the solvent used. After having added a solution of Q-Z to a colloidal solution of electrolyte nanoparticles, the reaction medium is left under stirring for 0 h to 24 hours (preferentially for 5 minutes to 12 hours, and even more preferentially for 0.5 hours to 2 hours), so that at least some and preferably all the Q-Z molecules can be grafted on the surface of the electrolyte nanoparticles. The functionalization can be implemented under heating, preferably at a temperature of between 20° C. and 100° C. The temperature of the reaction medium must be adapted to the selection of the functionalizing molecule Q-Z.

These functionalized nanoparticles therefore have a kernel (“core”) made from electrolyte material and a polymer shell, preferably PEO. The thickness of the shell may typically be between 1 nm and 100 nm; this thickness can be determined by transmission electron microscopy, typically after marking the polymer by ruthenium oxide (RuO₄).

Advantageously, the nanoparticles thus functionalized are next purified, preferably by successive centrifugation and redispersion cycles and/or by tangential filtration. In one embodiment, the colloidal suspension of functionalized electrolyte nanoparticles is centrifuged so as to separate the functionalized particles from the unreacted Q-Z molecules present in the supernatant. After centrifugation, the supernatant is eliminated. The residue comprising the functionalized particles is redispersed in the solvent. Advantageously, the residue comprising the functionalized particles is redispersed in a quantity of solvent making it possible to achieve the required dry extract. This redispersion can be implemented by any means, in particular by using an ultrasound bath or under magnetic and/or manual stirring.

Several successive centrifugation and redispersion cycles can be implemented so as to eliminate the Q-Z molecules that have not reacted. Preferably at least one, and even more preferentially at least two, successive centrifugation and redispersion cycles are implemented.

After redispersion of the functionalized electrolyte nanoparticles, the suspension can be reconcentrated until the required dry extract is achieved, by any suitable means.

Advantageously, the dry extract of a suspension of electrolyte nanoparticles functionalized by PEO comprises more than 40% (by volume) solid electrolyte material, preferably more than 60% and even more preferentially more than 70% solid electrolyte material.

Other Electrolytes that can be Used in Batteries According to the Invention

When the polymer employed as a shell in the core/shell particles is a grafted polymer including ion groups having lithium ions Li⁺ or a grafted polymer including OH groups the hydrogen of which has, at least partly, preferably completely, been substituted by lithium, it is possible to use as a core electrically insulating nanoparticles that are not necessarily conductive of lithium ions. By way of example, it is possible to use, as electrically insulating nanoparticles, nanoparticles of d′Al₂O₃, SiO₂ or ZrO₂.

5.2.4 Production of an Electrolyte Layer from Electrolyte Nanoparticles Functionalized by a Polymer on the Anodic Member and/or on the Cathode

The electrolyte nanoparticles functionalized by a polymer, as described above, can be deposited on the anodic member and/or on the cathode electrophoretically, by the dip coating method, by the ink-jet print method, by roll coating, by centrifugal coating, by curtain coating, by doctor blade, by coating of the slot-die type or by other suitable deposition techniques known to a person skilled in the art allowing the use of a suspension of functionalized electrolyte nanoparticles. These methods are simple, safe and easy to implement and to apply on an industrial scale. Electrophoresis or dip coating or coating of the slot-die type are preferred. These two coating techniques make it possible to easily produce compact defect-free layers.

Advantageously, the dry extract of the suspension of electrolyte nanoparticles functionalized by the polymer used for depositing a layer of electrolyte electrophoretically, by dip coating or by other deposition techniques known to a person skilled in the art according to the invention is less than 50% by mass; such a suspension is sufficiently stable during the deposition.

The coating methods can be used whatever the chemical nature of the nanoparticles employed, and are preferred when the electrolyte nanoparticles functionalized by polymer are little or not electron charged. They make it possible to simplify the management of the baths compared with the techniques of deposition electrophoretically, since the composition of the bath remains constant. The same remark applies to ink-jet printing, which makes it possible to make localized depositions, like the doctor-blade method through a mask. Electrophoresis makes it possible to deposit particles uniformly on large surfaces with a high deposition speed.

In order to obtain a layer with a required thickness, the step of deposition by dip coating of the electrolyte nanoparticles or functionalized by polymer followed by the step of drying the layer obtained are repeated as many times as necessary. Although this succession of steps of dip coating/drying are time-consuming, the method of deposition by dip coating is a simple, safe method, easy to implement and to apply on an industrial scale, and it makes it possible to obtain a homogeneous and compact final layer.

5.2.5 Drying and Densification of the Layer of Nanoparticles of Electrolyte Functionalized by a Polymer

After deposition, the solid layer of nanoparticles obtained must be dried. The drying must not cause the formation of cracks. For this reason, it is preferred to implement it under controlled conditions of moisture and temperature. We describe here a preferred embodiment with PEO, which can be used as well as other polymers, in particular those cited in section 5.2.1. The majority of the polymers, and in particular of these polymers, have neither electron conductivity nor ion conductivity. To make these polymers ion conductors, several methods are available. Lithium salts can be dissolved in the polymer, liquid electrolytes can be added in the polymer to make a gel thereof, or conductive nanoparticles can be added to the polymer; the latter embodiment is particularly advantageous. It is also possible to use as polymer grafted polymers including ion groups having lithium ions Li⁺ or grafted polymers including OH groups the hydrogen of which has been at least partly, preferably completely, substituted by lithium. This substitution can be implemented by a simple immersion of the core-shell particles including on the surface OH groups in a solution of LiOH at 80° C. for 8 h.

Advantageously, these layers have crystallized electrolyte nanoparticles bonded together by amorphous PEO. Advantageously, these layers have an electrolyte nanoparticle content greater than 35%, preferably greater than 50%, preferentially greater than 60% and even more preferentially greater than 70% by volume.

Advantageously, the electrolyte nanoparticles present in these layers have a D₅₀ size of less than 100 nm, preferably less than 50 nm and even more preferentially less than or equal to 30 nm; this value relates to the “core” of the “core-shell” nanoparticles. This particle size ensures good conductivity of the lithium ions between the electrolyte particles and the PEO.

The layer of electrolyte obtained after drying has a thickness of less than 15 μm, preferably less than 10 μm, preferably less than 8 μm, in order to limit the thickness and the weight of the battery without decreasing its properties.

The densification of this layer of nanoparticles is advantageously done at a subsequent stage of the method, namely during the assembly of the cell by thermocompression of the two subassemblies, anodic member and cathode, with this dried electrolyte film between the two. Densification makes it possible to reduce the porosity of the layer. The structure of the layer obtained after densification is continuous, almost without porosity, and the ions can migrate therein easily, without its being necessary to add liquid electrolytes containing lithium salts, such liquid electrolytes causing low thermal resistance of the batteries, and the resistance to aging of the batteries. The layers based on solid electrolyte and PEO obtained after drying and densification generally have a porosity of less than 20%, preferably less than 15% by volume, even more preferentially less than 10% by volume, and optimally less than 5% by volume. This value can be determined by transmission electron microscopy on a cross section.

In general terms, the densification of the electrolyte after deposition thereof can be implemented by any suitable means, preferably:

a) by any mechanical means, in particular by mechanical compression, preferably uniaxial compression;

b) by thermocompression, i.e. by heat treatment under pressure. The optimal temperature depends greatly on the chemical composition of the materials deposited, and especially of the polymer on the shell; it also depends on the sizes of particles and the compactness of the layer. A controlled atmosphere is preferably maintained in order to avoid oxidation and surface pollution of the particles deposited. Advantageously, the compacting is implemented under controlled atmosphere and at a temperature between ambient temperature and the melting point of the PEO employed; the thermal compression can be implemented at a temperature between ambient temperature (approximately 20° C.) and approximately 300° C.; but it is preferred not to exceed 200° C. (or even more preferentially 100° C.) in order to avoid degrading the PEO.

Densification of the electrolyte nanoparticles functionalized by PEO can be obtained solely by mechanical compression (applying a mechanical pressure) since the shell of these nanoparticles comprises PEO, a polymer that is easily deformable at a relatively low pressure. Advantageously, the compression is implemented in a pressure range between 10 MPa and 500 MPa, preferably between 50 MPa and 200 MPa, and at a temperature of the order of 20° C. to 200° C.

The inventors have observed that, at the interfaces, the PEO is amorphous and provides good ionic contact between the solid electrolyte particles. The PEO can thus conduct the lithium ions even in the absence of liquid electrolyte. It favors the assembly of the lithium-ion battery at low temperature, thus limiting the risk of interdiffusion at the interfaces between the electrolytes and the electrodes.

The layer of electrolyte obtained after densification has a thickness of less than 15 μm, preferably less than 10 μm, preferably less than 8 μm, in order to limit the thickness and the weight of the battery without reducing its properties.

As indicated above, the densification method that has just been described can be implemented when the battery is assembled; this assembly method will be described below.

5.3 Assembly of a Battery Comprising an Anodic Member According to the Invention and a Layer of Electrolyte Obtained from Electrolyte Nanoparticles Functionalized by Polymer

We describe here the production of a battery with an anodic member according to the invention and a layer of electrolyte obtained from electrolyte nanoparticles functionalized by polymer.

The layer of electrolyte is deposited by electrophoresis or by a coating technique (such as dip coating, extrusion coating through a die in the form of a slot, curtain coating) or by any other suitable means on at least one cathode layer 22 covering a substrate 21 and/or on at least one anodic member layer 12 covering a substrate 11, in both cases said substrate must have sufficient conductivity to be able to act as a cathodic or anodic current collector respectively.

The cathode layer and anodic-member layer are stacked, at least one of which is coated with the layer of electrolyte.

This stack comprising an alternating succession of cathode and anode, covered with a solid electrolyte layer, is next hot pressed under vacuum, it being understood that at least one anodic member according to the invention is used in this stack.

The assembly of the cell formed by an anodic member 12 according to the invention, the layer of electrolyte 13, 23 and a cathode layer 22 is implemented by hot pressing, preferably under inert atmosphere. The temperature is advantageously between 20° C. and 300° C., preferably between 20° C. and 200° C., and even more preferentially between 20° C. and 100° C. The pressure is advantageously uniaxial and between 10 MPa and 200 MPa, and preferentially between 50 MPa and 200 MPa.

In this way a cell is obtained that is completely solid and rigid.

We describe here another example of manufacture of a lithium-ion battery according to the invention. This method comprises the steps of:

(1) provision of:

(a) at least one conductive substrate previously covered with a cathode, hereinafter referred to as “cathode layer” 22,

(b) at least one conductive substrate previously covered with an anodic member according to the invention 12, and

(c) a colloidal suspension of core-shell nanoparticles comprising particles of a material that can serve as electrolyte, on which there is grafted a polymer shell, preferably made from PEO,

(2) deposition of a layer of said core-shell nanoparticles by any suitable means, preferably by slot-die coating, by the dip coating method, by the ink-jet printing method, by roll coating, by centrifugal coating, by curtain coating, by doctor blade, by electrophoretic deposition using said colloidal suspension on at least one cathode layer or anodic member obtained at step (1),

(3) drying the layer of electrolyte thus obtained, preferably under vacuum, or under anhydrous conditions,

(4) stacking the cathode layer and anodic member layer, at least one of which is coated with the layer of electrolyte 13, 23, and

(5) treating the stack of cathode layer and anodic member layer obtained at step (4) by mechanical compression and/or heat treatment so as to assemble the layers of electrolyte present on the cathode layer and anodic member layer.

Advantageously, step (5) is implemented by thermocompression at low temperature.

Once the assembly has been implemented, a rigid multilayer system consisting of one or more assembled cells is obtained.

When the anodic member and the anode according to the invention, in particular when the porous layer of a material conducting lithium ions, insulating with respect to electrons, is in contact with a layer of electrolyte obtained from solid electrolyte nanoparticles insulating with respect to electrons and functionalized by a polymer such as PEO, this makes it possible firstly to ensure good ionic contact between the anode according to the invention and the solid electrolyte, and secondly to avoid the appearance of lithium dendrites in the layer of electrolyte. This quality of ionic contact is related to the fact that the polymer shells such as PEO coat the surface of the nanoparticles of the anode according to the invention at the contact between the anode and this solid electrolyte, thus avoiding having punctiform contacts.

### 6. Encapsulation

The cells or the battery consisting of a plurality of elementary cells described above and completely rigid must next be encapsulated by a suitable method for ensuring protection thereof with regard to the atmosphere.

The present invention is compatible with various encapsulation systems or more generally packaging. By way of example, we describe here in detail a particular encapsulation system, with its deposition method, which is satisfactory for producing a battery that uses the anodic member that is the object of the present invention.

Because the battery in an operating state has an anode made from metallic lithium that has very great reactivity with respect to water, the encapsulation system must have excellent impermeability to water vapor and to oxygen. Because, during encapsulation of the battery, the anode does not yet contain metallic lithium (which is formed only during the charging of the battery), the methods for manufacturing the encapsulation, and in particular those of first layers, are not impacted by the presence of metallic lithium (which would risk polluting the reactors used for depositing certain layers of the encapsulation system by ALD).

The encapsulation system 30 comprises at least one layer, and preferably represents a stack of a plurality of layers. These encapsulation layers must be chemically stable in contact with metallic lithium and at the operating potential of the cathodes they must also withstand high temperatures and be perfectly impermeable to the atmosphere (barrier layer). It is possible to use one of the methods described in the patent applications WO 2017/115 032, WO 2016/001584, WO2016/001588 or WO 2014/131997.

In general terms, said at least one encapsulation layer must clad at least four of the six faces of said battery, and at least partially the other two faces of the battery that comprise the terminations. On these other two faces, it is possible to allow non-clad current collector tongues to project to take the connection. This avoids the difficulty of producing impermeable terminations with metals that are stable at the operating potentials of the anodes and cathodes.

Several embodiments can be envisaged for the encapsulation; more specifically, and by way of example, we here describe two of them.

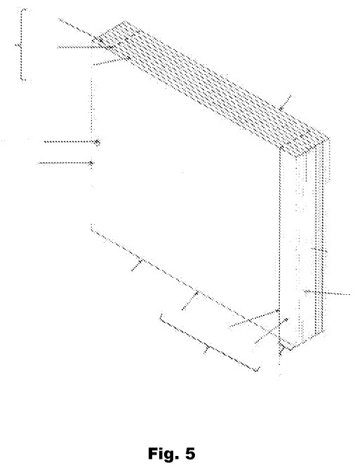

A first embodiment will be described in relation to FIGS. 5, 6, and 7.

According to this embodiment and as shown in FIG. 5, each cathode 1110 comprises a main body 1111, a secondary body 1112 located on a first lateral edge 1101, and a space 1113 free from any electrode material, electrolyte and/or current collector substrate. Said space, the width of which corresponds to that of the channel 1018 of the slot 1014 described above, extends between the longitudinal edges. In a similar manner, each anode 1130 comprises a main body 1131, and a secondary body 1132 located on the lateral edge 1102, opposite to the edge 1101. The main body 1131 and the secondary body 1132 are separated by a space 1133 free from any electrode material, electrolyte and/or current collector substrate, connecting the longitudinal edges, i.e. extending between the longitudinal edges 1103 and 1104. The two free spaces 1113 and 1133 are mutually symmetrical, with respect to the median axis Y100.

A first emerging hole 51 produced in the main body of the cathode extends in line with a second emerging hole produced in the secondary body of the anode, so that these holes extend in line with each other, and form a first emerging passage 61 that passes right through the battery, and so that the first emerging hole produced in the main body of the anode extends in line with a second emerging hole 52 produced in the secondary body of the cathode, so that the holes 52 extend in line with each other, and form a second emerging passage 63 that passes right through the battery.

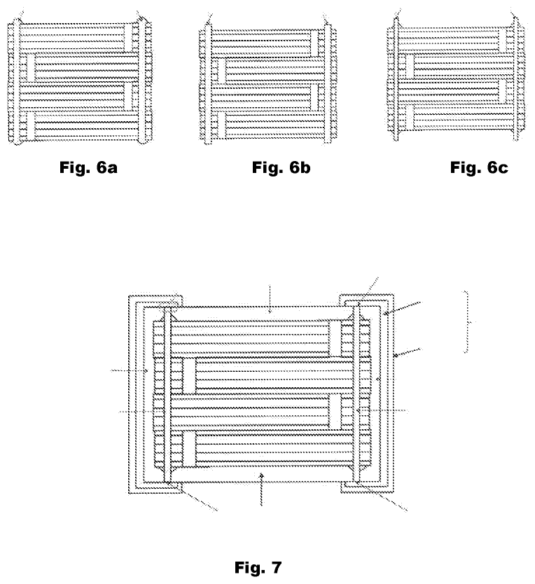

The first and second passages 61/63 provided on the battery according to the invention are filled with conductive means intended to produce the electrical connection between the cells of the battery as shown in FIGS. 6A, 6B, and 6C. These conductive means project at the top and bottom surfaces of the battery.

The conductive means can be obtained from electrically conductive materials. Advantageously, the WVTR coefficient of these conductive means is extremely low; these conductive means are impervious. They are in close contact with the electrical connection regions of the stack.

By way of example, the conductive means may be a bar formed from an electrically conductive material, such as a conductive glass or a metal introduced in the molten state or by any means adapted in the passage. At the end of solidification thereof, this material forms the aforementioned bar, the two opposite ends of which preferably define attachment heads as shown in FIG. 6A. The conductive means may also be a metal rod 71, 73 with a tight fit, the two opposite ends of which preferably define attachment heads, as shown in FIG. 6B. The conductive means may also be a metal rod surrounded by an electrically conductive sheath material, the sheath being able to be obtained from a glass or a metal introduced in the molten state or by any means adapted in the passage. At the end of solidification thereof, this material forms the metal rod surrounded by an aforementioned electrically conductive sheath material, the two opposite ends of which preferably define attachment heads as shown in FIG. 6C.

Advantageously, and in order to facilitate electrical contact between the current collector and the electrical connection regions, the conductive means employed and the collectors are of the same chemical nature. By way of example, use will preferably be made, in the anode end, of conductive means and anodic current collectors made from copper. Preferably, in the cathode end, the conductive means and the cathodic current collectors are produced from the same materials.

The top of each of these attachment heads or each of the opposite ends of the conductive means can define an electrical connection region, namely an anodic 75/75′ or cathodic 76/76′ anodic connection region of the battery according to the invention, so that the battery comprises at least one anodic connection region 75/75′ and at least one cathodic connection region 76/76′, as can be seen on FIG. 7.

This cell is encapsulated on its six faces, except at the points where the conductive means projects.

Advantageously, the battery or the assembly can be covered with an encapsulation system 30 formed by a stack of a plurality of layers, namely a sequence, preferably z sequences, comprising, successively, a first covering layer, preferably selected from parylene, type F parylene, polyimide, epoxy resins, polyamide and/or a mixture thereof, deposited on the stack of anode and cathode sheets, and a second covering layer composed of an electrically insulating material, deposited by atomic layer deposition on said first covering layer. Said second layer must be capable of acting as a barrier to the permeation of water. It must also be insulating. To obtain good barrier properties, ceramics, glasses and vitreous ceramics are preferred, all deposited by ALD or HDPCVD. On the other hand, polymers are certainly electrically insulating but not very impervious.

This sequence can be repeated at least once. This multilayer sequence has a barrier effect. The more the sequence of the encapsulation system is repeated, the greater will be this barrier effect. It will be all the greater, the more numerous the thin layers deposited.

Advantageously, the first covering layer is a polymeric layer made from epoxy resin, or from polyimide, from polyamide, or from poly-para-xylylene (better known by the term parylene), and preferably based on polyimide and/or parylene. This first covering layer makes it possible to protect the sensitive elements of the battery from its environment. The thickness of said first covering layer is preferably between 0.5 μm and 3 μm.

Preferably, for the first encapsulation layer, a material that is extremely stable in contact with metallic lithium is selected, such as parylene or a polyimide. Moreover, the parylene used as the first encapsulation layer is produced from a monomer that is a fairly large molecule compared with the size of the mesoporosities of the host structure; thus it does not enter the mesoporosity lattice during its deposition by ALD, but closes the access to the nanoporosities during the formation of the polymer film. Other polymers that are stable in contact with lithium such as a polyimide can also be used.

Advantageously, the first covering layer can be made from type C parylene, from type D parylene, from type N parylene (CAS 1633-22-3), from type F parylene or a mixture of parylene of types C, D, N and/or F. Parylene (also called polyparaxylylene or poly(p-xylylene)) is a dielectric, transparent, semi-crystalline material that has great thermodynamic stability, excellent resistance to solvents and very low permeability. Parylene also has barrier properties making it possible to protect the battery from its external environment. The protection of the battery is increased when this first covering layer is produced from type F parylene. It can be deposited under vacuum, by a chemical vapor deposition (CVD) technique.

This first encapsulation layer is advantageously obtained by the condensation of gaseous monomers deposited by a chemical vapor deposition (CVD) technique on the surfaces, which makes it possible to have a conformal, thin and uniform covering of the whole of the surfaces of the stack that are accessible. It makes it possible to follow the variations in volume of the battery during operation thereof and facilitates the clean cutting of the batteries through its elastic properties.

The thickness of this first encapsulation layer is between 2 μm and 10 μm, preferably between 2 μm and 5 μm and even more preferentially approximately 3 μm. It makes it possible to cover all the accessible surfaces of the stack, to close only on the surface access to the pores of the anodic member according to the invention of these accessible surfaces and to make the chemical nature of the substrate uniform. The first covering layer does not enter the pores of the anodic member, the size of the polymers deposited being too great for them to enter the pores of the stack.

This first covering layer is advantageously rigid; it cannot be considered to be a flexible surface.

In one embodiment a first layer of parylene is deposited, such as a layer of parylene C, parylene D, a layer of parylene N (CAS 1633-22-3) or a layer comprising a mixture of parylene C, D and/or N. Parylene (also called polyparaxylylene or poly(p-xylylene)) is a transparent semi-rigid dielectric material that has great thermodynamic stability, excellent resistance to solvents and very low permeability.

This layer of parylene protects the sensitive elements of the battery from the environment. This protection is increased when this first encapsulation layer is produced from parylene N. However, the inventors have observed that this first layer, when it is based on parylene, does not have sufficient stability in the presence of oxygen, and the impermeability thereof is not always satisfactory. When this first layer is based on polyimide, it does not have sufficient impermeability, in particular in the presence of water. For these reasons advantageously a second layer that coats the first layer is advantageously deposited.

Advantageously, a second covering layer composed of an electrically insulating material, preferably inorganic, is deposited by a conformal deposition technique, such as atomic layer deposition (ALD), on this first layer. In this way a conformal covering is obtained of all the accessible surfaces of the stack previously covered with the first covering layer, preferably with a first layer of parylene and/or polyimide; this second layer is preferably an inorganic layer.

The growth of the layer deposited by ALD is influenced by the nature of the substrate. A layer deposited by ALD on a substrate having various regions of different chemical natures will have a non-homogeneous growth, which may cause a loss of integrity of this second protective layer.

The techniques of deposition by ALD are particularly well adapted for covering surfaces having high roughness in a completely impervious and conforming manner. They make it possible to produce conformal layers free from defects, such as holes (so-called “pinhole free” layers) and represent very good barriers. Their WVTR coefficient is extremely low. The WVTR (water vapor transmission rate) coefficient makes it possible to evaluate the permeability to water vapor of the encapsulation system: the lower the WVTR coefficient, the more impervious is the encapsulation system. By way of example, a layer of Al₂O₃ 100 nm thick deposited by ALD has a permeability to water vapor of 0.00034 g/m².d. The second covering layer may be made from ceramic material, from vitreous material or from vitreous ceramic material, for example in the form of oxide, of the Al₂O₃, nitride, phosphates, oxynitride, or siloxane type. This second covering layer has a thickness of less than 200 nm, preferably between 50 nm and 200 nm, more preferentially between 10 nm and 100 nm, between 10 nm and 5 nm, and even more preferentially of the order of around fifty nanometers.

This second covering layer makes it possible firstly to ensure the impermeability of the structure, i.e. to prevent the migration of water inside the structure, and secondly to protect the first covering layer from the atmosphere and thermal exposures in order to avoid degradation thereof. This second layer improves the service life of the encapsulated battery.

However, these layers deposited by ALD are very fragile mechanically and require a rigid support surface for providing their protective role. Depositing a fragile layer on a flexible surface would lead to the formation of cracks, causing a loss of integrity of this protective layer.

Advantageously, a third covering layer is deposited on the second covering layer or on an encapsulation system 30 formed by a stack of a plurality of layers as described previously, namely a sequence, preferably z sequences of the encapsulation system, with z≥1, to increase the protection of the battery cells from their external environment. Typically, this third layer is made from polymer, for example from silicone (deposited for example by impregnation or by plasma enhanced chemical vapor deposition using hexamethyldisiloxane (HMDSO)), or from epoxy resin, or from polyimide, or from parylene. Said third layer may also be composed of a glass with a low melting point, preferably a glass the melting point of which is below 600° C. It can be deposited by HDPCVD (High Density Plasma Chemical Vapor Deposition). The glass with a low melting point can in particular be selected from SiO₂—B₂O₃; Bi₂O₃—B₂O₃, ZnO—Bi₂O₃—B₂O₃, TeO₂—V₂O₅ and P_{b}O—SiO₂.

Furthermore, the encapsulation system may comprise an alternating succession of layers of parylene and/or polyimide, preferably approximately 3 μm thick, and layers composed of an electrically insulating material such as inorganic layers deposited conformally by ALD or HDPCVD to create a multilayer encapsulation system. In order to improve the performances of the encapsulation, the encapsulation system may advantageously comprise a first layer of parylene and/or of polyimide, preferably approximately 3 μm thick, a second layer composed of an electrically insulating material, preferably an inorganic layer, deposited conformally by ALD or HDPCVD on the first layer, a third layer of parylene and/or polyimide, preferably approximately 3 μm thick, deposited on the second layer, and a fourth layer composed of an electrically insulating material deposited conformally by ALD or HDPCVD on the third layer.

The battery or the assembly thus encapsulated in this sequence of the encapsulation system, preferably in z sequences, can next be covered with a last covering layer so as to mechanically protect the stack thus encapsulated and optionally confer an aesthetic appearance thereon. This last covering layer protects and improves the service life of the battery. Advantageously, this last covering layer is also selected to withstand a high temperature, and has sufficient mechanical strength for protecting the battery during subsequent use thereof. Advantageously, the thickness of this last covering layer is between 1 μm and 50 μm. Ideally, the thickness of this last covering layer is approximately 10-15 μm, such a thickness range makes it possible to protect the battery against mechanical damage.

Advantageously a last covering layer is deposited on an encapsulation system formed by a stack of a plurality of layers as described above, namely a sequence, preferably z sequences of the encapsulation system with z≥1, preferably on this alternating succession of layers of parylene or polyimide, preferably approximately 3 μm thick, and of inorganic layers deposited conformally by ALD or HDPCVD, to increase the protection of the battery cells from the external environment thereof and to protect them against mechanical damage. This last encapsulation layer preferably has a thickness of approximately 10-15 μm.

This last covering layer is preferably based on epoxy resin, polyethylene naphthalate (PEN), polyimide, polyamide, polyurethane, silicone, sol-gel silica or organic silica or glass deposited by HDPCVD. Advantageously, this last covering layer is deposited by dip coating. Typically, this last layer is made from polymer, for example silicone (deposited for example by dip coating or by plasma enhanced chemical vapor deposition using hexamethyldisiloxane (HMDSO)), or from epoxy resin, or from polyimide, or from parylene. For example, a layer of silicone can be deposited by injection (typical thickness approximately 15 μm) to protect the battery against mechanical damage. The selection of such a material stems from the fact that withstands high temperatures and the battery can thus be assembled easily by welding on electronic cards without the appearance of glass transitions. Advantageously, the encapsulation of the battery is implemented on at least four of the six faces of the stack. The encapsulation layers surround the periphery of the stack, the remainder of the protection against the atmosphere being provided by the layers obtained by the terminations.

### 7. Terminations

The correct selection of the terminations is important in the context of the present invention, because of the very greatly reducing potential of the anode. In general terms the electrical connections must be implemented with materials stable at the operating potential of the various electrodes. For example, the copper terminations can be produced at the anode, and at the cathode it is possible to use conductive inks with carbon fillers.

The terminations can be deposited locally on the metal substrates in order to leave a resist. Next the entire battery is encapsulated and then the contacts are taken by cutting the projecting tongue.

These electrical contact regions are preferably disposed on opposite sides of the stack of the battery to collect the current. The connections are metalized by means of techniques known to a person skilled in the art.

The terminations can be implemented in the form of a single metal layer, of tin for example, or consist of multilayers. Preferably, the terminations are formed in the region of the cathode and anode connections, by a first stack of layers comprising successively a first layer of conductive polymer, such as a resin with silver filler, a second layer of nickel deposited on the first layer and a third layer of tin deposited on the second layer. The layers of nickel and tin can be deposited by electrodeposition techniques.

In this three-layer complex, the layer of nickel protects the layer of polymer during the steps of assembly by welding, and the layer of tin provides the weldability of the interface of the battery.

The terminations make it possible to take the positive and negative electrical connections, preferably on the opposite faces of the battery. The cathode connections preferably emerge on a lateral side of the battery, and the anode connections are preferably available on the other lateral side.

### 8. Charging the Battery

So that the battery can operate, it must be charged. In the battery according to the invention, when the battery is first charged, the pores of the anodic member will be loaded with metallic lithium; it is in this way that the anode of the battery will become functional. The electron conduction in this anode will take place by means of the lithium that will be deposited in the pores of the host porous layer (anodic member).

The anodic member according to the invention is porous, preferably mesoporous: it has a very large specific surface area. These characteristics confer low ionic resistance on the anode of the battery.

The battery comprising an anodic member according to the invention may in particular be a lithium ion battery having a capacity greater than approximately 1 mAh. It may in particular be a so-called power battery, which can be used as a secondary battery for powering autonomous devices such as hand tools or transport devices (bicycles, cars), or for absorbing electric energy generated by intermittent power generators (wind turbines, photovoltaic modules etc).

The batteries comprising an anodic member according to the invention can be produced with cathodes that are:
either layers of the “all solid” type, i.e. with no liquid or viscous phases impregnated (said liquid or viscous phases being able to be a medium conducting lithium ions, capable of acting as an electrolyte),
or layers of the mesoporous “all solid” type, impregnated with a liquid or viscous phase, typically a medium conducting lithium ions, which spontaneously enters inside the layer and which no longer emerges from this layer, so that this layer can be considered to be quasi-solid,
or impregnated porous layers (i.e. layers having a lattice of open pores that can be impregnated with a liquid or viscous phase, and which confers wet properties on these layers).

### 9. Advantages of the Invention

The invention has many advantages, only a few aspects of which are indicated here.

Using anodes made from metallic lithium was known, but, due to the great sensitivity of this metal with respect to moisture, it is necessary to provide a particularly effective encapsulation system. The best barrier layers are obtained by means of techniques for depositing thin layers by ALD and/or HDPCVD, but these depositions are made in chambers under vacuum and at a temperature above ambient temperature: because of the high vapor pressure of lithium, these deposition techniques are not compatible with an anode made from metallic lithium. Moreover, during the charging and discharging cycles of the battery, lithium anodes have variations in volume of the order of 100%. If the encapsulation system is not able to accommodate this variation in volume, it will crack and there will be a loss of impermeability.

The invention solves all these problems by using an anode made from metallic lithium formed in a host structure (anodic member). Such an anode no longer exhibits any variation in volume of the anode during the charging-discharging cycles of the battery. Moreover, the lithium anode is not yet formed when the encapsulation is implemented, and it is then possible to use techniques of the ALD and HDPCVD type, which make it possible to obtain encapsulation layers that are highly impermeable with respect to moisture and oxygen.

Moreover, the known metallic lithium anodes have a planar exchange surface with the solid electrolyte; the exchange surface is very small. This limits the power of the battery. The battery according to the invention has an anode having a very large exchange surface by virtue of the deposition of the lithium in a mesoporous host structure (anodic member). The very large specific surface area of the host structure considerably reduces the local densities of currents of the anode using this porous layer (anodic member), which favors the nucleation and the homogeneous deposition of the metallic lithium in this structure. The increase in the specific surface area thus improves the efficiencies of the final battery and avoids the formation of punctiform defects during the steps of deposition and extraction of lithium. In this way it is possible to obtain a battery having a very high power density. The combination of the anodic member according to the invention with a solid electrolyte formed from nanoparticles of the core-shell type, with a shell made from a polymer material that is a good conductor of lithium ions or which has been rendered a good ion conductor, provides good ionic contact between the anode and the electrolyte, and inhibits the formation of lithium dendrites.

### 10. Supplementary Remarks on the Design of Batteries According to the Invention

The anodic member according to the invention, which transforms into an anode during the first charging of the battery by the deposition (“plating”) of metallic lithium in the mesoporous open lattice of the anodic member, can be used for manufacturing battery cells having a very high energy density. In order to balance the cells, it is necessary to put the anodes facing the cathodes having approximately the same powers per unit surface and where the capacity per unit surface of the anode is slightly greater than that of the cathode to avoid the lithium coming into contact with the solid electrolyte and creating lithium dendrites in the electrolyte.

Moreover, in the technology according to the present invention, the electrodes cannot be impregnated after the cell is assembled: impregnation by a liquid electrolyte would make liquid enter the mesoporous structure of the host structure (i.e. in the anodic member) serving as an anode, no longer leaving any space for the plating of the metallic lithium. The cathode and the electrolyte must consequently be solid to allow the assembly and the operation of the cell.

For the cathode, either a dense thick electrode is selected, but this electrode will then be highly resistive. For example, if the electron conductivity of LiMn₂O₄ is taken to be equal to 10⁻² S/cm, and a dense deposition of approximately 100 μm thick, then the resistance of an electrode of 1 cm² will be of the order of 10 kOhms. Thus, to combine a high thickness and a high power density, advantageously in the context of the present invention a cathode architecture is used in which a mesoporous deposition of nanoparticles of cathode material has previously been implemented. This cathode is subjected to a heat treatment (“sintering”) until a porosity of approximately 30% is obtained (which makes it possible to preserve both an open porosity and good energy density per unit volume). This architecture in which the nanoparticles are sintered makes it possible to dispense with the use of organic binders. Since these binders are not conductors of ions, the fact that they partially cover the surface of the active materials also reduces the power of the battery cell; this problem is not posed with the at least partially sintered nanoparticles.

The specific surface area of such a cathode is very high. Producing a deposition of nanometric thickness of an electron-conducting layer, such as carbon, on this internal specific surface area makes it possible to considerably reduce the series (ohmic) resistance of the battery. This reduction is all the greater, the larger the specific surface area of the cathode and the higher the conductivity of the surface graphite; said conductivity increases with the thickness of the deposit.

Such a mesoporous cathode can be obtained by a method wherein:

(a) a substrate and a colloidal suspension are provided, comprising aggregates or agglomerates of monodisperse primary nanoparticles of at least one active cathode material, with a mean primary diameter D₅₀ of between 2 nm and 100 nm, preferably between 2 nm and 60 nm, said aggregates or agglomerates having a mean diameter D₅₀ of between 50 nm and 300 nm, preferably between 100 nm and 200 nm,

(b) a layer is deposited on said substrate using said colloidal suspension provided at step (a), by a step preferably selected from the group formed by: electrophoresis, a print method, preferably selected from ink-jet printing and flexographic printing, and a coating method, preferably selected from roll coating, curtain coating, doctor-blade coating, extrusion coating through a die in the form of a slot, and dip coating;

(c) said layer obtained at step (b) is dried and is consolidated, by pressing and/or heating, to obtain a porous layer, preferably mesoporous and inorganic,

(d) a coating of an electron-conducting material is deposited, on and inside the pores of said porous layer, so as to form said porous electrode.

It is thus possible to obtain cathodes comprising a porous layer deposited on a substrate, said layer being for example free from binder, having a porosity of between 20% and 60% by volume, preferably between 25% and 50%, and pores with a mean diameter of less than 50 nm.

Said substrate can be the layer of electrolyte described above.

This large specific surface area of the cathode also makes it possible to reduce the resistance to ion transport. Thus, in an advantageous embodiment, the electrode is impregnated, after the deposition of an electron-conducting nanolayer, with an ion conductor. This ion conductor may be liquid or solid, or a gel (for example a polymer impregnated with a liquid electrolyte). It fills in the porosities. Said ion conductor may be an ion-conducting polymer, as described above in section 5.2.1; it is possible to use PEO (with or without lithium salt) molten so as to be sufficiently liquid in order to wet in the mesoporosities. It is also possible to impregnate with molten ion-conducting glasses (for example a glass of the borate type, mixed with borate and phosphate) or with a sulfide.

The risk of forming lithium dendrites through the solid electrolyte films is dealt with by using a hybrid solid electrolyte, consisting of nanoparticles of lithiated phosphates, conducting lithium ions and chemically stable in a wide potential range (which ranges from 0 to 6 V approximately). The polymers stated above (for example the polymers of the PEO type) are lithiophilic and conduct the lithium ions when they are amorphous. Adding lithium salts and other ionic liquids to these polymers leads to maintaining an amorphous structure, conducting lithium ions, but gives rise to a risk of formation of dendrites in the polymer; this risk does not exist when these polymers are in a dry amorphous form.

In the same manner, in ceramic oxides, the formation of dendrites is all the less probable when the solid electrolyte material is a good electron insulator. Solid electrolytes of the NASICON type are much better electron insulators than garnets for example, but in all these structures it is the grain joints that remain the weak points in terms of electron conductivity, and which risk having propagations of metallic lithium dendrites initiated.

Thus, in order to have a solid electrolyte film that is a good ion conductor and a good electron insulator, not giving any risks of formation of dendrites, advantageously an electrolyte is used provided with a core-shell structure, wherein the polymer molecules (for example of the PEO type) without liquid electrolyte, surround nanoparticles of solid electrolyte materials of the NASICON type. The nanoconfinement of the polymer molecules, such as PEO, around the solid electrolyte nanoparticles makes it possible to keep it in an amorphous state with good ion conduction properties, without adding lithium salts. The PEO shell provides good ionic contact with the anode according to the invention.

In a variant of this embodiment, a mesoporous separator based on electrochemically stable and electron-insulating nanoparticles is deposited on the mesoporous cathode coated with its electron-conducting nanocoating. This separator is impregnated, at the same time as the cathode, with an ion-conducting polymer. This polymer, for example PEO, optionally mixed with lithium salts and/or optionally mixed with ionic liquids, is heated so as to be sufficiently liquid to be able to impregnate the electrode and the electrolytic separator, both mesoporous.

### EXAMPLES

### Example 1: Producing the Mesoporous Host Structure (Anodic Member) Based on Li_{1.4}Ca_{0.2}Zr_{1.8}(PO₄)₃

A first, aqueous, solution is prepared: 30 ml of water was poured into a beaker, and 2.94 g of lithium phosphate (LiH₂PO₄) was added under stirring. The solution was maintained under stirring until the lithium phosphate is completely dissolved. First 2.17 mL of orthophosphoric acid (H₃PO₄, 85% wt in water) was added, and then 0.944 g of calcium nitrate (Ca(NO₃)₂·4H₂O); a perfectly clear aqueous solution was obtained.

A second, alcoholic, solution was prepared: 16.13 mL of zirconium n-propoxide in solution in n-propanol ((Zr(OPr)₄, zirconium (IV) propoxide, solution at 70 wt. % in 1-propanol, CAS No. 23519-77-9), was diluted in 100 mL of anhydrous ethanol.

The alcoholic solution was then stirred by means of a homogenizer of the Ultra-Turrax™ type, then the aqueous solution was quickly added, under brisk stirring, to the alcoholic solution; the stirring was continued for 15 minutes. A viscous reaction medium was obtained containing a white precipitate in suspension. The reaction medium was next centrifuged at 4000 rpm for 20 minutes. The colorless supernatant was eliminated.

The centrifugation pots containing the precipitate were then placed in a stove under vacuum in order to dry the precipitate for one night at 50° C. The dried precipitate was then granulated via a nylon sieve with a 500 μm mesh, using a nylon spatula. The powder thus obtained was next calcined for one hour at 700° C. 76 g of calcined powder, 2300 g of ethanol and yttriated zirconium oxide beads with a diameter of 0.1 mm were next introduced into a ball grinder of make WAB. The calcined powder was next ground for 90 minutes in a ball grinder. A colloidal solution the particle size of which is between 10 nm and 50 nm was obtained.

The particles of the colloidal solution were next functionalized with polyvinylpyrrolidone (PVP: Mw=55,000 g/mol). To do this, the colloidal solution was introduced into a water-ethanol mixture, and the PVP was introduced into this mixture to the extent of 10% by mass with respect to the Li_{1.4}Ca_{0.2}Zr_{1.8}(PO₄)₃. The suspension was next concentrated under vacuum to a dry extract of 30%. This concentrated solution was deposited by doctor blade on a copper substrate. After drying, the layer was calcined at 400° C. in air in order to eliminate the organics, followed by a second rapid stage to 650-700° C. under inert atmosphere in order to complete the recrystallization of the deposit. The film obtained has a porosity of the order of 50%.

### Example 2: Production of a Cladding by ALD on the Mesoporous Host Structure (Anodic Member) Based on Li_{1.4}Ca_{0.2}Zr_{1.8}(PO₄)₃

A thin layer of ZnO is deposited on the mesoporous host structure based on Li_{1.4}Ca_{0.2}Zr_{1.8}(PO₄)₃ disposed on its copper substrate obtained according to example 1, in an ALD reactor of the P300B type (supplier: Picosun), at an argon pressure of 2 mbar at 180° C. The argon was here used both as a carrier gas and for purging. Before each deposition, a drying time of 3 hours was applied. The precursors used were water and diethyl zinc. A deposition cycle consisted of the following steps: injection of diethyl zinc, purging of the chamber with Ar, injection of water, purging of the chamber with Ar.

This cycle is repeated to achieve a thickness of coating of 1.5 nm. After these various cycles, the product was dried under vacuum at 120° C. for 12 hours to eliminate the residues of reagents on the surface.

### Example 3: Producing a Mesoporous Cathode Based on LiMn₂O₄

A suspension of nanoparticles of LiMn₂O₄ was prepared by hydrothermal synthesis in accordance with the method described in the article by Liddle and al. entitled “A new one pot hydrothermal synthesis and electrochemical characterization of Li₁₊ₓMn_{2-y}O₄ spinel structured compounds”, Energy & Environmental Science (2010) vol. 3, page 1339-1346. 14.85 g of LiOH, H₂O was dissolved in 500 ml of water. 43.1 g of KMnO₄ was added to this solution and this liquid phase was poured into an autoclave. Under stirring, 28 ml of isobutyraldehyde and water were added until a total volume of 3.54 l was reached. The autoclave was then heated to 180° C. and maintained at this temperature for 6 hours. After slow cooling, a black precipitate in suspension in the solvent was obtained. This precipitate was subjected to a succession of steps of centrifugation and redispersion in water until an aggregated suspension was obtained with a conductivity of approximately 300 μS/cm and a zeta potential of −30 mV. The aggregates obtained consisted of aggregated primary particles with a size of 10 to 20 nm. The aggregates obtained had a spherical shape and a mean diameter of approximately 150 nm; they were characterized by X-ray diffraction and electron microscopy.

Approximately 10 to 15% by mass polyvinylpyrrolidone (PVP) at 360,000 g/mol was next added to the aqueous suspension of aggregates. The water was evaporated until the suspension of aggregates has a dry extract of 10%. The ink thus obtained was applied to a stainless steel strip (316L) with a thickness of 5 μm. The layer obtained was dried in a stove controlled for temperature and humidity in order to avoid the formation of cracks on drying. The deposition of ink and the drying were repeated to obtain a layer approximately 10 μm thick.

This layer was consolidated at 600° C. for 1 h in air in order to weld the primary nanoparticles together, to improve the adhesion of the substrate and to complete the recrystallization of the LiMn₂O₄. The porous layer thus obtained has an open porosity of approximately 45% by volume with pores with a size of between 10 nm and 20 nm. The porous layer was next impregnated with a saccharose solution and was then annealed at 400° C. under N₂ in order to obtain a nanocoating of carbon over the whole of the accessible surface.

### Example 4: Manufacture of a Battery Using an Anodic Member According to the Invention

Mesoporous host structures (anodic member) based on Li_{1.4}Ca_{0.2}Zr_{1.8}(PO₄)₃ with a thickness of approximately 100 μm were produced according to example 1. A layer of ZnO according to example 2 was applied. The anodic current collector was made from Ti, Ni or Mo (thickness approximately 5 μm to 10 μm).

Cathodes were produced from Li_{1.2}Ni_{0.13}Mn_{0.54}Co_{0.13}O₂ with a thickness of 150 μm with a mesoporosity of 35%; a nanocoating of carbon was applied as described at the end of example 3 above. The cathodic current collector was made from Cu or Mo (thickness approximately 5 μm to 10 μm). The cathodes were impregnated with a solution comprising PEO and molten lithium 2-trifluoromethyl-4,5-dicyanoimidazole (LiTDI). The ionic liquid instantaneously enters the porosities by capillarity. The system was maintained in immersion for 1 minute, and then the surface was dried with a wave of N₂.

A dense layer of nanoparticles of Li_{1.4}Ca_{0.2}Zr_{1.8}(PO₄)₃ coated with PEO was deposited (alternatively: nanoparticles of Li_{1.5}Al_{0.5}Ge_{1.5}(PO₄)₃ coated with PEO) on the anodic member and on the cathode; these nanoparticles had a polydisperse size distribution as described in the particular embodiment in the description part.

The two subsystems were assembled so that the layer of Li_{1.4}Ca_{0.2}Zr_{1.8}(PO₄)₃ coated with PEO are in contact. This assembly was implemented by pressing; in this way a cell was formed.

### Example 5: Manufacture of a Battery Using an Anodic Member According to the Invention

Other batteries according to the invention that had the following structure were manufactured.

The anodic collector was a copper or molybdenum sheet with a thickness of approximately 5 μm to 10 μm. The anodic member, deposited on this collector, had a thickness of approximately 100 μm and was made from Li_{1.4}Ca_{0.2}Zr_{1.8}(PO₄)₃ with a mesoporosity of approximately 50%; a coating of ZnO was deposited in this mesoporous lattice by ALD.

The cathodic current collector was titanium, nickel or molybdenum sheet with a thickness of approximately 5 to 10 μm. The cathode, deposited on this collector with a thickness of approximately 150 μm, was made from Li_{1.2}Ni_{0.13}Mn_{0.54}Co_{0.13}O₂, with a mesoporosity of approximately 35%; a carbon coating was deposited in this mesoporous lattice by ALD or CSD. The separator was a layer of Li_{1.4}Ca_{0.2}Zr_{1.8}(PO₄)₃ or Li_{1.5}Al_{0.5}Ge_{1.5}(PO₄)₃ with PEO. The electrolyte impregnating the cathode was PEO comprising LiTDI.

This battery has a capacity density per unit volume of approximately 400 mAh/cm³ and an energy density per unit volume of approximately 1450 mWh/cm³.

### Example 6: Manufacture of a Battery Using an Anodic Member According to the Invention

Other batteries according to the invention that had the same structure as those of example 5 were manufactured, but with the following differences:

The anodic member had a thickness of approximately 55 μm.

The cathode was made from LiMn_{1.5}Ni_{0.5}Mn_{0.5}O₄, its thickness was approximately 150 μm with a mesoporosity of approximately 35% and a carbon coating in this mesoporous lattice.

This battery had a capacity density per unit volume of approximately 220 mAh/cm³ and an energy density per unit volume of approximately 1000 mWh/cm³.

### LIST OF REFERENCE SYMBOLS

1 Battery
11 Layer of a substrate serving as a current collector
12 Layer of an active anode material/anodic member according to the invention
13 Layer of a solid electrolyte material
21 Layer of a substrate serving as a current collector
22 Layer of an active cathode material
23 Layer of a solid electrolyte material
30 Encapsulation system
40 Termination
45 Weld zone between the porous layer and the substrate
46 Pore
47 Lithiophilic layer deposited on the accessible surface of the electrodes
48 Lithiophilic layer deposited on the accessible surface of the substrate
50 Anodic and/or cathodic connections
51 First emerging hole produced in the main body of the cathode
52 Second emerging hole produced in the secondary body of the cathode
56 Strip of cathodic material separating the hole 51 from the free lateral edge
57 Strip of cathodic material separating the hole 52 from the free lateral edge
61 First emerging passage
63 Second emerging passage
71 Cathodic conductive means
71′ Cathodic conductive means
71″ Cathodic conductive means
73 Anodic conductive means
73′ Anodic conductive means
73″ Anodic conductive means
75 Anodic connection region
76 Cathodic connection region
80 Encapsulation system
90 Termination
91 First layer of conductive polymer of the terminations
75 Anodic connection region
75′ Anodic connection region
76 Cathodic connection region
76′ Cathodic connection region
92 Second nickel layer of the terminations
93 Third tin layer of the terminations
100 Battery
1100 Battery
1101 First lateral edge
1102 Second lateral edge
1103 First longitudinal edge
1104 Second longitudinal edge
1110 Cathode layer
1111 Main body of cathode layer
1112 Secondary body of cathode layer
1113 Free space between 1111 and 1112
1130 Layer of the anodic member
1131 Main body of the anodic member layer
1132 Secondary body of the anodic member
1133 Free space between 1131 and 1132
L1112 Width of the secondary body 1112
L1113 Width of the free space between 1111 and 1112
X100 Longitudinal medium axis of the battery
Y100 Lateral medium axis of the battery

1-22. (canceled)

23. A method for manufacturing an anodic member of a lithium-ion battery having a capacity greater than 1 mA h and which includes at least one cathode, at least one electrolyte, and at least one anode that includes said anodic member, said method comprising:
(a) providing a substrate and a colloidal suspension comprising aggregates or agglomerates of monodisperse nanoparticles of at least one first electrically insulating material conducting lithium ions with a mean primary diameter of between 5 nm and 100 nm, said aggregates or agglomerates having a mean diameter of less than 500 nm;
(b) depositing a porous layer on a surface of said substrate via by a method selected from a group formed by electrophoresis, ink-jet printing, doctor blade, spraying, flexographic printing, roll coating, curtain coating, slot-die coating, and dip coating, using said colloidal suspension, wherein said substrate is an intermediate substrate or is operable to serve as a collector of electrical current of the battery; and
(c) drying said porous layer under a flow of air, where applicable before or after having separated said porous layer from said intermediate substrate, and then, conducting a heat treatment on the dried porous layer,
wherein said anodic member includes the porous layer, the porous layer having a porosity of between 35% and 70% by volume.

24. The method of claim 23, wherein when substrate is an intermediate substrate:
step (a) further includes: providing at least one electrically conductive sheet to serve as a current collector of the battery, and providing a conductive glue or a colloidal suspension comprising monodisperse nanoparticles of at least one second material conducting lithium ions with a mean primary diameter of between 5 nm and 100 nm, and
after separating said porous layer from said intermediate substrate and conducting a heat treatment of the porous layer, depositing a thin layer of conductive glue or a thin layer of nanoparticles on at least one face of said electrically conductive sheet, the thin layer of conductive glue or the thin layer of nanoparticles being deposited from the colloidal suspension comprising monodisperse nanoparticles of at least one second material conducting lithium ions, the at least one second material conducting lithium ions being identical to the first material conducting lithium ions, and
adhesively bonding said porous layer on said at least one face of said electrically conductive sheet.

25. The method of claim 23, wherein, after step (c):
(d) depositing, by atomic layer deposition (ALD) or chemical solution deposition (CSD), a layer of a lithiophilic material on and inside pores of the porous layer.

26. The method of claim 25, wherein the lithiophilic material is selected from ZnO, Al, Si, and CuO.

27. The method of claim 23, wherein the substrate is a metal substrate selected from copper strips, nickel strips, molybdenum strips, and alloy strips that comprise at least copper, nickel, or chromium.

28. The method of claim 23, wherein the primary diameter of said monodisperse nanoparticles is between 10 nm and 30 nm.

29. The method of claim 23, wherein the mean diameter of the pores of the porous layer is between 8 nm and 30 nm.

30. The method of claim 23, wherein the porous layer has a porosity of approximately 50% by volume.

31. The method of claim 23, wherein said material conducting lithium ions is selected from the group formed by:
lithiated phosphates selected from lithiated phosphates that include: NaSICON, Li₃PO₄; LiPO₃; Li₃Al_{0.4}Sc_{1.6}(PO₄)₃ called «LASP»; Li₁₊ₓZr₂₋ₓCaₓ(PO₄)₃ with 0≤x≤0.25; Li₁₊₂ₓZr₂₋ₓCaₓ(PO₄)₃ with 0≤x≤0.25 such as Li_{1.2}Zr_{1.9}Ca_{0.1}(PO₄)₃ or Li_{1.4}Zr_{1.8}Ca_{0.2}(PO₄)₃; LiZr₂(PO₄)₃; Li₁₊₃ₓZr₂(P₁₋ₓSiₓO₄)₃ with 1.8<x<2.3; Li₁₊₆ₓZr₂(P₁₋ₓBₓO₄)₃ 0≤x≤0.25; Li₃(Sc₂₋ₓMₓ)(PO₄)₃ with M=Al or Y and 0≤x≤1; Li₁₊ₓMₓ(Sc)₂₋ₓ(PO₄)₃ with M=Al, Y, Ga or a mixture of the three compounds and 0≤x≤0.8; Li₁₊ₓMₓ(Ga_{1-y}Sc_{y})₂₋ₓ(PO₄)₃ with 0≤x≤0.8; 0≤y≤1 and M=Al or Y or a mixture thereof; Li₁₊ₓMₓ(Ga)₂₋ₓ(PO₄)₃ with M=Al, Y or a mixtures of the two compounds and 0≤x≤0.8; Li_{3+y}(Sc₂₋ₓMₓ)Q_{y}P_{3-y}O₁₂ with M=Al and/or Y and Q=Si and/or Se, 0≤x≤0.8 and 0≤y≤1; or Li_{1-x-y}MₓSc₂₋ₓQ_{y}P_{3-y}O₁₂ with M=Al, Y, Ga or a mixture thereof and Q=Si and/or Se, 0≤x≤0.8 and 0≤y≤1; or Li_{1+x+y+z}Mₓ(Ga_{1-y}Sc_{y})₂₋ₓQ_{z}P_{3-z}O₁₂ with 0≤x≤0.8, 0≤y≤1, 0≤z≤0.6 with M=Al or Y or a mixture thereof and Q=Si and/or Se; or Li₁₊ₓZr₂₋ₓBₓ(PO₄)₃ with 0≤x≤0.25; or Li₁₊ₓZr₂₋ₓCaₓ(PO₄)₃ with 0≤x≤0.25; or Li₁₊ₓM³ₓM₂₋ₓP₃O₁₂ with 0≤x≤1 and M³=Cr, V, Ca, B, Mg, Bi and/or Mo, M=Sc, Sn, Zr, Hf, Se or Si, or a mixture thereof;
lithiated borates selected from: Li₃(Sc₂₋ₓMₓ)(BO₃)₃ with M=Al or Y and 0≤x≤1; Ie Li₁₊ₓMₓ(Sc)₂₋ₓ(BO₃)₃ with M=Al, Y, Ga or a mixture thereof and 0≤x≤0.8; Li₁₊ₓMₓ(Ga_{1-y}Sc_{y})₂₋ₓ(BO₃)₃ with 0≤x≤0.8, 0≤y≤1 and M=Al or Y; Li₁₊ₓMₓ(Ga)₂₋ₓ(BO₃)₃ with M=Al, Y or a mixture thereof and 0≤x≤0.8; Li₃BO₃, Li₃BO₃—Li₂SO₄, Li₃BO₃—Li₂SiO₄, Li₃BO₃—Li₂SiO₄—Li₂SO₄; Li₃Al_{0.4}Sc_{1.6}(BO₃)₃; Li₁₊ₓZr₂₋ₓCaₓ(BO₃)₃ with 0≤x≤0.25; Li₁₊₂ₓZr₂₋ₓCaₓ(BO₃)₃ with 0≤x≤0.25 such as Li_{1.2}Zr_{1.9}Ca_{0.1}(BO₃)₃ or Li_{1.4}Zr_{1.8}Ca_{0.2}(BO₃)₃; LiZr₂(BO₃)₃; Li₁₊₃ₓZr₂(B₁₋ₓSiₓO₃)₃ with 1.8<x<2.3; Li₁₊₆ₓZr₂(P₁₋ₓBₓO₄)₃ with 0≤x≤0.25; Li₃(Sc₂₋ₓMₓ)(BO₃)₃ with M=Al and/or Y and 0≤x≤1; Li₁₊ₓMₓ(Sc)₂₋ₓ(BO₃)₃ with M=Al, Y, Ga or a mixture thereof and 0≤x≤0.8; Li₁₊ₓMₓ(Ga_{1-y}Sc_{y})₂₋ₓ(BO₃)₃ with 0≤x≤0.8; 0≤y≤1 and M=Al and/or Y; Li₁₊ₓMₓ(Ga)₂₋ₓ(BO₃)₃ with M=Al and/or Y 0≤x≤0.8; Li_{3+y}(Sc₂₋ₓMₓ)Q_{y}B_{3-y}O₉ with M=Al and/or Y and Q=Si and/or Se, 0≤x≤0.8 and 0≤y≤1; or Li_{1-x-y}MₓSc₂₋ₓQ_{y}B_{3-y}O₉ with M=Al, Y, Ga or a mixture thereof and Q=Si and/or Se, 0≤x≤0.8 and 0≤y≤1; or Li_{1+x+y+z}Mₓ(Ga_{1-y}Sc_{y})₂₋ₓQ_{z}B_{3-z}O₉ with 0≤x≤0.8, 0≤y≤1, 0≤z≤0.6 with M=Al and/or Y and Q=Si and/or Se; or Li₁₊ₓZr₂₋ₓBₓ(BO₃)₃ with 0≤x≤0.25; or Li₁₊ₓZr₂₋ₓCaₓ(BO₃)₃ with 0≤x≤0.25; or Li₁₊ₓM³ₓM₂₋ₓ(BO₃)₃ with 0≤x≤1 and M³=Cr, V, Ca, B, Mg, Bi and/or Mo, M=Sc, Sn, Zr, Hf, Se or Si, or a mixture thereof;
oxynitrides selected from Li₃PO₄₋ₓN_{2x/3} and Li₃BO₃₋ₓN_{2x/3} with 0<x<3;
lithiated compounds based on lithium phosphorus oxynitride (LiPON) in a form of LiₓPO_{y}N_{z} with x˜2.8 and 2y+3z˜7.8 and 0.16≤z≤0.4, Li_{2.9}PO_{3.3}N_{0.46}, Li_{w}POₓN_{y}S_{z} with 2x+3y+2z=5=w, or Li_{w}POₓN_{y}S_{Z} with 3.2≤x≤3.8, 0.13≤y≤0.4, 0≤z≤0.2, 2.9≤w≤3.3, or LiₜPₓAl_{y}OᵤNᵥS, with 5x+3y=5, 2u+3v+2w=5+t, 2.9≤t≤3.3, 0.84≤x≤0.94, 0.094≤y≤0.26, 3.2≤u≤3.8, 0.13≤v≤0.46, 0≤w≤0.2;
materials based on lithium phosphorus (LiPON) or lithium boron oxynitrides (LIBON) that are able to contain silicon, sulfur, zirconium, aluminum, or a combination of aluminum, boron, sulfur and/or silicon, and boron for materials based on lithium phosphorus oxynitrides;
lithiated compounds based on lithium silicon phosphorus oxynitride (LiSiPON), including Li_{1.9}Si_{0.28}P_{1.0}O_{1.1}N_{1.0};
lithium oxynitrides of the LiBON, LiBSO, LiSiPON, LiSON, thio-LiSiCON and LiPONB types, where B, P and S represent respectively boron, phosphorus and sulfur;
lithium oxides of an LiBSO type, including (1−x)LiBO₂-xLi₂SO₄ with 0.4≤x≤0.8;
silicates selected from Li₂Si₂O₅, Li₂SiO₃, Li₂Si₂O₆, LiAlSiO₄, Li₄SiO₄, and LiAlSi₂O₆;
solid electrolytes of an anti-perovskite type that are selected from: Li₃OA with A being a halide or a mixture of halides, at least one element selected from F, Cl, Br, I or a mixture thereof; Li₍₃₋ₓ₎M_{x/2}OA with 0<x≤3, M a divalent metal, at least one element selected from Mg, Ca, Ba, Sr or a mixture thereof, with A being a halide or a mixture of halides, at least one element selected from F, Cl, Br, I or a mixture thereof; Li₍₃₋ₓ₎M³_{x/3}OA with 0≤x≤3, M³ a trivalent metal, A being a halide or a mixture of halides, at least one element selected from F, Cl, Br, I or a mixture thereof; or LiCOX_{z}Y_{(1-z)}, with X and Y being halides as mentioned above in relation to A, and 0≤z≤1.

32. The method of claim 23, wherein, during an initial charging of the lithium-ion battery, the pores of said porous layer are loaded with metallic lithium.

33. A method for manufacturing a non-charged lithium-ion battery having a capacity greater than 1 mA h, the method comprising:
preparing an anodic member disposed on a metal substrate or adhesively bonded to an electrically conductive sheet, said metal substrate or said electrically conductive sheet being configured to serve as a current collector of the non-charged lithium-ion battery;
preparing a cathode on a second metal substrate configured to serve as a current collector of the non-charged lithium-ion battery;
depositing a colloidal suspension of solid electrolyte particles on the anode member and/or the cathode, and then drying the colloidal suspension; and
stacking, face-to-face, the anodic member and the cathode, and then thermopressing the stack.

34. The method of claim 33, wherein the colloidal suspension comprises aggregates or agglomerates of monodisperse nanoparticles of at least one first electrically insulating material conducting lithium ions with a mean primary diameter of between 5 nm and 100 nm, said aggregates or agglomerates having a mean diameter of less than 500 nm.

35. The method of claim 34, further comprising:
depositing at least one porous layer on said metal substrate and/or said cathode layer, by electrophoresis, inkjet printing, doctor blade, spraying, flexographic printing, roller coating, curtain coating, or dip coating, using said colloidal suspension;
drying the deposited at least one porous layer; and
conducting a heat treatment on the dried at least one porous layer before or after separating the at least one porous layer from the metal substrate, the heat treatment being conducting under an oxidizing atmosphere;
depositing on at least one face of said electrically conductive sheet, a thin layer of conductive glue or a thin layer of nanoparticles using the colloidal suspension comprising monodisperse nanoparticles of at least a second material conducting lithium ions, the second material conducting the lithium ions being identical to the first material conducting lithium ions;
adhesively bonding the porous layer on said at least one face of said electrically conductive sheet;
depositing, by atomic layer deposition (ALD), a layer of a lithiophilic material on and inside the pores of the porous layer;
depositing a layer of solid electrolyte on the cathode layer and/or on the porous layer, said layer of solid electrolyte being obtained from an electrolyte material having an electron conductivity of less than 10⁻¹¹ S/cm, electrochemically stable in contact with metallic lithium and at an operating potential of the cathode, having an ion conductivity greater than 10⁻⁵ S/cm;
drying the deposited layer of solid electrolyte;
producing a stack comprising an alternating succession of cathode layers and porous layers that are offset laterally; and
hot pressing the stack to juxtapose films present on the anode layers and the cathode layers, so as to obtain an assembled stack.

36. The method of claim 35, wherein depositing the layer of solid electrolyte is implemented using a suspension of core-shell nanoparticles comprising particles of a material that serve as an electrolyte, on which a polymer shell is grafted, selected from a group formed by polyethylene oxide (PEO), polypropylene oxide (PPO), polydimethylsiloxane (PDMS), polyacrylonitrile (PAN), polymethyl methylmethacrylate, abbreviated (PMMA), polyvinyl chloride (PVC), polyvinylidene difluoride (PVDF), polyvinylidene fluoride-co-hexafluoropropylene, and polyacrylic acid (PAA).

37. The method of claim 36, wherein the polymer shell of the core-shell nanoparticles is a grafted polymer including ion groups having lithium ions or OH groups the hydrogen of which has at least totally been substituted by lithium.

38. The method of claim 35, further comprising, after obtaining the assembled stack:
depositing on the assembled stack successively, in alternation, an encapsulation system that comprises a first polymer layer, followed by a second inorganic insulating layer, wherein said polymer layer is selected from parylene, type F parylene, polyimide, epoxy resins, polyamide and a mixture thereof, and said second inorganic insulating layer is selected from ceramics, glasses, and vitroceramics, and
repeating the depositing in sequence several times.

39. A method of manufacturing a battery having a capacity greater than 1 mA h, the method comprising:
providing a substrate and a colloidal suspension comprising aggregates or agglomerates of monodisperse nanoparticles of at least one first electrically insulating material conducting lithium ions with a mean primary diameter of between 5 nm and 100 nm, said aggregates or agglomerates having a mean diameter of less than 500 nm;
depositing a porous layer on a surface of said substrate via by a method selected from a group formed by electrophoresis, ink-jet printing, doctor blade, spraying, flexographic printing, roll coating, curtain coating, slot-die coating, and dip coating, using said colloidal suspension, wherein said substrate is an intermediate substrate or is operable to serve as a collector of electrical current of the battery; and
drying said porous layer under a flow of air, where applicable before or after having separated said porous layer from said intermediate substrate, and then, conducting a heat treatment on the dried porous layer; and
loading the pores of the porous layer with metallic lithium during an initial charging of the battery.

40. The method of claim 35, wherein the porous layer has a porosity of between 35% and 70% by volume.
